(19) United States
(12) Patent Application Publication
(10) Pub. No.: US 2026/0010150 A1
(43) Pub. Date: Jan. 8, 2026

(54) HOME APPLIANCE AND SERVER THAT COMMUNICATES WITH THE HOME APPLIANCE

(71) Applicant: Samsung Electronics Co., Ltd., Suwon-si (KR)

(72) Inventors: Nokhaeng LEE, Suwon-si (KR); Hyeonah JUNG, Suwon-si (KR); Daekee KIM, Suwon-si (KR); Sangjin KIM, Suwon-si (KR); Sungjong KIM, Suwon-si (KR); Gyusung NA, Suwon-si (KR); Minseok PARK, Suwon-si (KR); Seungjun LEE, Suwon-si (KR); Sung HAN, Suwon-si (KR); Kwanwoo HONG, Suwon-si (KR)

(21) Appl. No.: 19/220,861

(22) Filed: May 28, 2025

Related U.S. Application Data
(63) Continuation of application No. PCT/KR2025/006948, filed on May 22, 2025.

(30) Foreign Application Priority Data
Jul. 2, 2024 (KR) 10-2024-0087103
Oct. 15, 2024 (KR) 10-2024-0140197

(51) Int. Cl. G05B 23/02; D06F 34/05; D06F 34/18; D06F 34/26; D06F 58/20; D06F 103/18; D06F 105/02; D06F 105/08; H04L 12/28

(52) U.S. Cl. CPC G05B 23/0216; D06F 34/05; D06F 34/18; D06F 34/26; D06F 58/206; H04L 12/2823; D06F 2103/18; D06F 2105/02; D06F 2105/08

(57) ABSTRACT

A home appliance is provided. The home appliance includes at least one processor configured to control operations for the plurality of loads based on diagnosis control information in response to a command to perform a first diagnosis mode being selected through the input module, control the communication module to transmit, to a server, control information for the plurality of loads and detection information detected by the at least one sensor while performing the first diagnosis mode, and control the output module to output diagnosis result information received from the server, control the communication module to transmit, to the server, and control information for at least one of the plurality of loads and detection information detected by the at least one sensor in response to a command to perform a second diagnosis mode being received through the input module during operation of the at least one load.

### CROSS-REFERENCE TO RELATED APPLICATION(S)

This application is a continuation application, claiming priority under 35 U.S.C. § 365 (c), of an International application No. PCT/KR2025/006948, filed on May 22, 2025, which is based on and claims the benefit of a Korean patent application number 10-2024-0087103, filed on Jul. 2, 2024, in the Korean Intellectual Property Office, and of a Korean patent application number 10-2024-0140197, filed on Oct. 15, 2024, in the Korean Intellectual Property Office, the disclosure of each of which is incorporated by reference herein in its entirety.

### BACKGROUND

### 1. Field

The disclosure relates to a home appliance for failure diagnosis and a server for communicating with the home appliance.

### 2. Description of Related Art

Home appliances refer to devices used to increase user convenience by using electricity. There are various types of home appliances, such as a clothes treating apparatus, a dish washer, a refrigerator, an air conditioner, a dehumidifier, a humidifier, a cooking device, a television, or the like.

A home appliance displays a fault code on a display device, such as an light emitting diode (LED) or a small liquid crystal display (LCD) attached onto the home appliance or outputs an indication sound of a particular pattern representing the fault code.

When a failure of the home appliance is notified to the user through the display device or the indication sound, the user determines a cause of the failure by referring to a manual of the home appliance or needs to request a repair of the failure from a service center after identifying the fault code displayed on the display device.

It is a hassle for the user to refer to the manual in person to determine the failure of the home appliance, and when the user requests the repair of the failure from the service center, time and money is consumed and human resources of the service center is wasted.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a home appliance configured to control an operation for each load based on diagnosis control information in response to a command to perform a first diagnosis mode being received, transmit, to a server, control information for each load and detection information of each sensor during the operation for each load, transmit, to the server, control information for at least one load and detection information of each sensor in response to a command to perform a second diagnosis mode being received during operation of the at least one load.

Another aspect of the disclosure is to provide a server configured to diagnose a failure of a home appliance based on at least one of control information for each load of the home appliance and detection information of each sensor of the home appliance received from the home appliance or a user device, and transmit diagnosis result information to the home appliance or the user device.

Additional aspects will be set forth in part in the description which follows and, in part, will be apparent from the description, or may be learned by practice of the presented embodiments.

### Technical Solution

In accordance with an aspect of the disclosure, a home appliance is provided. The home appliance includes an input module configured to receive a user input, an output module, a communication module configured to perform communication with a server, a plurality of loads, at least one sensor, memory, including one or more storage media, storing instructions, and at least one processor communicatively coupled to the input module, the output module, the communication module, the plurality of loads, the at least one sensor and the memory, wherein the instructions, when executed by the at least one processor individually or collectively, cause the home appliance to control operations of the plurality of loads based on diagnosis control information in response to a command to perform a first diagnosis mode being selected through the input module, control the communication module to transmit, to a server, control information for the plurality of loads and detection information detected by the at least one sensor while performing the first diagnosis mode, control the output module to output diagnosis result information received from the server, control the communication module to transmit, to the server, and control information for at least one of the plurality of loads and detection information detected by the at least one sensor in response to a command to perform a second diagnosis mode being received through the input module during operation of at least one load of the plurality of loads.

The at least one sensor of the home appliance includes at least one of a microphone for detecting sound and a vibration sensor for detecting vibration.

The instructions, when executed by the at least one processor individually or collectively, further cause the home appliance to store at least one of sound information detected by the microphone and vibration information detected by the vibration sensor based on a performance time of the first diagnosis mode as being matched with the control information for the plurality of loads and the detection information detected by at least one sensor.

The instructions, when executed by the at least one processor individually or collectively, further cause the home appliance to control the second diagnosis mode to be performed for a reference diagnosis time.

The instructions, when executed by the at least one processor individually or collectively, further cause the home appliance to store at least one of sound information detected by the microphone and vibration information detected by the vibration sensor based on a performance time of the second diagnosis mode as being matched with the control information for the plurality of loads and the detection information detected by the at least one sensor.

The communication module is configured to perform communication with a user device and receive sound information collected from the user device. The instructions, when executed by the at least one processor individually or collectively, further cause the home appliance to control the communication module to transmit, to the server, sound information received while performing the first diagnosis mode as being matched with the control information for the plurality of loads and the detection information of the at least one sensor, and control the communication module to transmit, to the server, sound information received while performing the second diagnosis mode as being matched with control information for at least one load and the detection information of the at least one sensor.

The communication module is configured to perform communication with a user device and receive vibration information collected by the user device. The instructions, when executed by the at least one processor individually or collectively, further cause the home appliance to control the communication module to transmit, to the server, vibration information received while performing the first diagnosis mode as being matched with the control information for the plurality of loads and the detection information of the at least one sensor, and control the communication module to transmit, to the server, vibration information received while performing the second diagnosis mode as being matched with control information for at least one load and the detection information of the at least one sensor.

The communication module of the home appliance is configured to communicate with a user device. The instructions, when executed by the at least one processor individually or collectively, further cause the home appliance to control the first diagnosis mode to be performed based on a command to perform the first diagnosis mode being received from the user device, and control the second diagnosis mode to be performed based on a command to perform the second diagnosis mode being received from the user device.

Based on diagnosis result information being received from the user device, the instructions, when executed by the at least one processor individually or collectively, further cause the home appliance to control the output module to output the received diagnosis result information.

The plurality of loads of the home appliance include a driving motor configured to rotate a drum arranged in a tub, a drain pump configured to discharge water out of the tub, and a water supply valve configured to supply water into the tub. The instructions, when executed by the at least one processor individually or collectively, further cause the home appliance to control a washing process, a water supply process, a dehydrating process and a draining process based on diagnosis control information, recognize whether the drum is unloaded during the washing process, and controls the output module to output indication information requesting to draw out laundry based on the drum being recognized as loaded.

The instructions, when executed by the at least one processor individually or collectively, further cause the home appliance to control a washing process, a water supply process, a dehydrating process and a draining process based on the drum being unloaded, control the driving motor, the drain pump and the water supply valve, and recognize control information for the driving motor, control information for the drain pump and control information for the water supply valve.

The home appliance further includes a water level sensor configured to detect a water level in the tub, and a speed sensor configured to detect rotation speed of the driving motor. The instructions, when executed by the at least one processor individually or collectively, further cause the home appliance to control the communication module to transmit, to the server, water level information detected by the water level sensor and rotation speed information detected by the speed sensor.

The home appliance further includes a current sensor configured to detect a current flowing to the driving motor. The instructions, when executed by the at least one processor individually or collectively, further cause the home appliance to recognize current process information based on a command to perform the second diagnosis mode being received, recognize weight information of laundry based on current information detected by the current sensor, and control the communication module to transmit, to the server, the recognized current process information, weight information of the laundry and water level information.

The home appliance further includes a driving motor configured to rotate a drum arranged in a tub, and a drying device configured to dry laundry in the drum. The drying device of the home appliance includes a heat pump including a compressor, a blower fan configured to blow air produced through the heat pump into the drum, and a cooling fan configured to cool the compressor. The instructions, when executed by the at least one processor individually or collectively, further cause the home appliance to control a drying process based on the diagnosis control information, and recognize control information for the driving motor, control information for the compressor, control information for the blower fan and control information for the cooling fan while controlling the drying process.

The home appliance further includes a first speed sensor configured to detect rotation speed of the driving motor, a second speed sensor configured to detect rotation speed of a motor for compressor arranged in the compressor, a third speed sensor configured to detect rotation speed of a first motor arranged in the blower fan, and a fourth speed sensor configured to detect rotation speed of a second motor arranged in the cooling fan. The instructions, when executed by the at least one processor individually or collectively, further cause the home appliance to control the communication module to transmit, to the server, rotation speed information detected by the first, second, third and fourth speed sensors while controlling the drying process.

In accordance with another aspect of the disclosure, a server is provided. The server includes a communication module configured to communicate with a home appliance and a user device, memory, including one or more storage media, storing instructions, and at least one processor communicatively coupled to the communication module and the memory, wherein the instructions, when executed by the at least one processor individually or collectively, cause the server to diagnose a failure of the home appliance based on the reference diagnosis information, control information for a plurality of loads received from the home appliance and sound information received from the user device, and control the communication module to transmit diagnosis result information to at least one of the home appliance and the user device.

The instructions, when executed by the at least one processor individually or collectively, further cause the server to diagnose a failure of the home appliance based on the reference diagnosis information, control information for a plurality of loads received from the home appliance and vibration information received from the user device.

The instructions, when executed by the at least one processor individually or collectively, further cause the server to control the communication module to transmit, to the home appliance, diagnosis control information required to perform a first diagnosis mode.

The instructions, when executed by the at least one processor individually or collectively, further cause the server to diagnose a failure related to the plurality of loads based on performance information of the first diagnosis mode and detection information of a plurality of sensors arranged in the home appliance being received from the home appliance, and diagnose a failure related to at least one of the plurality of loads based on performance information of the second diagnosis mode and control information for the at least one load being received from the home appliance.

The instructions, when executed by the at least one processor individually or collectively, further cause the server to diagnose a failure of the home appliance based on at least one of the reference diagnosis information, control information for the plurality of loads received from the home appliance and sound information and vibration information received from the home appliance in response to at least one of the sound information and the vibration information being received from the home appliance.

In accordance with another aspect of the disclosure, one or more non-transitory computer-readable storage media storing one or more computer programs including computer-executable instructions that, when executed by one or more processors of a home appliance including an input module configured to receive a user input, an output module, a communication module configured to perform communication with a server, a plurality of loads, at least one sensor, memory, comprising one or more storage media, storing instructions, at least one processor communicatively coupled to the input module, the output module, the communication module, the plurality of loads, the at least one sensor and the memory, individually or collectively, cause the home appliance to perform operations are provided. The operations include controlling operations of the plurality of loads based on diagnosis control information in response to a command to perform a first diagnosis mode being selected through the input module, controlling the communication module to transmit, to the server, controlling information for the plurality of loads and detection information detected by the at least one sensor while performing the first diagnosis mode, controlling the output module to output diagnosis result information received from the server, controlling the communication module to transmit, to the server, and controlling information for at least one of the plurality of loads and detection information detected by the at least one sensor in response to a command to perform a second diagnosis mode being received through the input module during operation of at least one load of the plurality of loads.

According to the disclosure, a failure from fastening errors, installation errors or faults of various loads (e.g., various motors, various valves, various pumps, or compressors) of the home appliance based on control information for each load of the home appliance and detection information of each sensor of the home appliance is diagnosed, and the diagnosis result information is output through the home appliance or a user device so that the user easily perceive the failure of the home appliance.

According to the disclosure, a server that is rich in calculation and memory resources is used to diagnose a failure of the home appliance, so that the failure of the home appliance is diagnosed quickly and accurately.

According to the disclosure, information about fastening errors, installation errors or faults of various loads of the home appliance is collected and learned for each type of the home appliance and for each model of the home appliance, diagnosis control information is updated using the collected and learned information for each home appliance, and failure diagnosis performance of the home appliance is improved by diagnosing the failure of the home appliance based on the updated diagnosis control information. Accordingly, more accurate services is provided to the user.

According to the disclosure, a failure of a home appliance that is not equipped with a microphone or a vibration sensor also be diagnosed by using a user device. This increases user convenience.

According to the disclosure, safety of the home appliance is improved, quality and marketability of the home appliance is improved, and furthermore, competitiveness of the home appliance is ensured.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a home network system including home appliances according to an embodiment of the disclosure;

FIG. 2 is a block diagram of a home network system including home appliances according to an embodiment of the disclosure;

FIG. 3 illustrates a clothes treating apparatus among home appliances according to an embodiment of the disclosure;

FIG. 4 is a cross-sectional view of a clothes treating apparatus according to an embodiment of the disclosure;

FIG. 5 illustrates an interior of a clothes treating apparatus according to an embodiment of the disclosure;

FIG. 6 is a diagram illustrating components arranged in a clothes treating apparatus viewed from a direction different from a direction of FIG. 5 according to an embodiment of the disclosure;

FIG. 7 is a control block diagram of a clothes treating apparatus according to an embodiment of the disclosure;

FIGS. 8A and 8B illustrate a control panel equipped in a clothes treating apparatus according to various embodiments of the disclosure;

FIG. 9 illustrates control over a plurality of loads in a laundry mode during a first diagnosis mode of a clothes treating apparatus according to an embodiment of the disclosure;

FIG. 10 illustrates control over a plurality of loads in a drying mode during a first diagnosis mode of a clothes treating apparatus according to an embodiment of the disclosure;

FIG. 11 is a control flowchart of a first diagnosis mode of a clothes treating apparatus according to an embodiment of the disclosure;

FIG. 12 is a control flowchart of a second diagnosis mode of a clothes treating apparatus according to an embodiment of the disclosure;

FIG. 13 is a control block diagram of a server that communicates with a clothes treating apparatus according to an embodiment of the disclosure;

FIG. 14 is a block diagram of a home network system including a home appliance according to an embodiment of the disclosure;

FIGS. 15A, 15B, and 15C illustrate displays on a user device that communicates with a home appliance according to various embodiments of the disclosure; and

FIG. 16 is a control block diagram of a user device that communicates with a home appliance according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is understood that various embodiments of the disclosure and associated terms are not intended to limit technical features herein to particular embodiments of the disclosure, but encompass various changes, equivalents, or substitutions.

Like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

Terms like “first”, “second”, or the like, may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

The expression “and/or” is interpreted to include a combination or any of associated elements.

The principle and embodiments of the disclosure will now be described with reference to accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

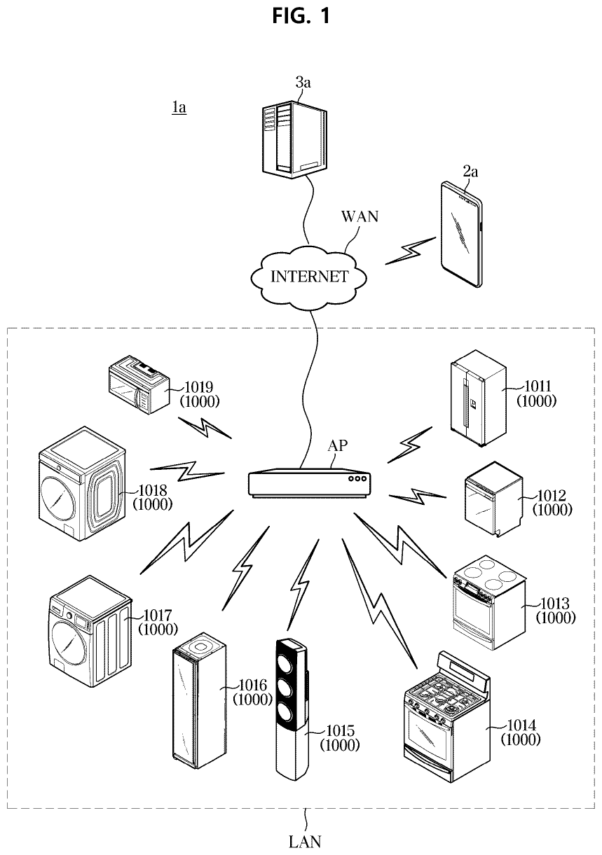

FIG. 1 illustrates a home network system including home appliances according to an embodiment of the disclosure.

Referring to FIG. 1, a home network system 1a may include at least one home appliance 1000, a user device 2a and a server 3a.

The home appliance 1000 may include a communication module for communicating with another home appliance, the user device 2a or the server 3a, a user interface for receiving user inputs or outputting information for the user, at least one processor for controlling operation of the home appliance 1000, and at least one memory for storing a program for controlling the operations of the home appliance 1000.

The home appliance 1000 may be at least one of various types of home appliances. For example, the home appliance 1000 may include at least one of a refrigerator 1011, a dish washer 1012, an electric range 1013, an electric oven 1014, an air conditioner 1015, a garment care system 1016, a washing machine 1017, a dryer 1018, or a microwave oven 1019 as shown, but is not limited thereto. For example, the home appliance 1000 may include various types of home appliances, such as a cleaning robot, a vacuum cleaner, a television, or the like, not shown in the drawing. The aforementioned home appliances are merely an example, and in addition to the aforementioned home appliances, any device connected to another home appliance, the user device 2a or the server 3a and able to perform operations as will be described later may belong to the home appliance 1000 according to an embodiment.

The server 3a may include a communication module for communicating with another server, the home appliance 1000 or the user device 2a, at least one processor for processing data received from the other server, the home appliance 1000 or the user device 2a, and at least one memory for storing a program for processing data or storing the processed data.

The server 3a may be implemented with various computing devices, such as a workstation, a cloud, a data drive, a data station, or the like. The server 3a may be implemented with one or more servers physically or logically classified based on function, sub-configuration of the function or data, and may transmit or receive data through inter-server communication and process the data.

The server 3a may perform functions, such as managing a user account, registering the home appliance 1000 by connecting the home appliance 1000 to the user account, and managing or controlling the registered home appliance 1000. For example, the user may access the server 3a through the user device 2a to create a user account. The user account may be identified by an identity (ID) and a password created by the user.

The server 3a may register the home appliance 1000 with the user account according to a set procedure. For example, the server 3a may connect identification information (e.g., a serial number, a media access control (MAC) address, or the like) of the home appliance 1000 to the user account to register, manage and control the home appliance 1000.

The user device 2a may include a communication module for communicating with the home appliance 1000 or the server 3a, a user interface for receiving user inputs or outputting information for the user, at least one processor for controlling operations of the user device 2a, and at least one memory for storing a program for controlling the operations of the user device 2a.

The user device 2a may be carried by the user or placed at the user's home or office. The user device 2a may include a personal computer, a terminal, a portable telephone, a smart phone, a handheld device, a wearable device, or the like, without being limited thereto.

In the memory of the user device 2a, a program for controlling the home appliance 1000, i.e., an application, may be stored. The application may be sold in a state of being installed in the user device 2a, or may be downloaded and installed from an external server.

The user may access the server 3a and create a user account by running the application installed in the user device 2a, and sign up the home appliance 1000 by communicating with the server 3a based on the login user account.

For example, when the home appliance 1000 is operated to access the server 3a according to a procedure guided in the application installed in the user device 2a, the server 3a may sign up the home appliance 1000 with the user account by registering the identification information (e.g., a serial number or a MAC address) of the home appliance 1000 with the user account.

The user may use the application installed in the user device 2a to control the home appliance 1000. For example, when the user logs in on the user account with the application installed in the user device 2a, the home appliance 1000 registered with the user account may appear, and when a control command is input for the home appliance 1000, the control command may be forwarded to the home appliance 1000 through the server 3a.

A network may include both a wired network and a wireless network. The wired network may include a cable network or a telephone network, and the wireless network may include any network that transmits or receives signals in radio waves. The wired network and the wireless network may be connected to each other.

The network may include a wide area network (WAN), such as the Internet, a local area network (LAN) formed around an access point (AP), and a short-range wireless network without an AP. The short-range wireless network may include Bluetooth (IEEE 802.15.1), Zigbee (IEEE 802.15.4), wireless fidelity (Wi-Fi) direct, near field communication (NFC), Z-wave, or the like, without being limited thereto.

The AP may connect the home appliance 1000 or the user device 2a to the WAN connected to the server 3a. The home appliance 1000 or the user device 2a may be connected to the server 3a through the WAN.

The AP may use wireless communication, such as Wi-Fi (IEEE 802.11), Bluetooth (IEEE 802.15.1), Zigbee (IEEE 802.15.4), or the like, to communicate with the home appliance 1000 or the user device 2a, and use wired communication to access the WAN, but is not limited thereto.

In various embodiments of the disclosure, the home appliance 1000 may be directly connected to the user device 2a or the server 3a without passing through the AP.

The home appliance 1000 may be connected to the user device 2a or the server 3a over a long-range wireless network or a short-range wireless network.

For example, the home appliance 1000 may be connected to the user device 2a over a short wireless network (e.g., Wi-Fi direct).

In another example, the home appliance 1000 may use the long-range wireless network (e.g., a cellular communication module) to be connected to the user device 2a or the server 3a through the WAN.

In another example, the home appliance 1000 may connect to the WAN by using wired communication, and connect to the user device 2a or the server 3a through the WAN.

When the home appliance 1000 is able to access the WAN through the wired communication, the home appliance 1000 may operate as an AP. Accordingly, the home appliance 1000 may connect another home appliance to the WAN to which the server 3a is connected. Furthermore, the other home appliance may connect the home appliance 1000 to the WAN to which the server 3a is connected.

The home appliance 1000 may transmit information about the operation or status to another home appliance, the user device 2a or the server 3a over the network. For example, on receiving a request from the server 3a or when a particular event occurs in the home appliance 1000, the home appliance 1000 may transmit the information about the operation or the status to the other home appliance, the user device 2a or the server 3a periodically or in real time.

On receiving the information about the operation or status from the home appliance 1000, the server 3a may update information about the operation or status that has been stored, and transmit the updated information about the operation and status of the home appliance 1000 to the user device 2a over the network. The updating of the information may include various operations to change the existing information, such as adding new information to the existing information, replacing the existing information with new information, or the like.

The home appliance 1000 may obtain various information from another home appliance, the user device 2a or the server 3a, and provide the obtained information to the user. For example, the home appliance 1000 may obtain information about a function of the home appliance 1000 (e.g., cooking instructions, washing instructions, or the like) or various environmental information (e.g., weather, temperature, humidity, or the like) from the server 3a, and output the obtained information through the user interface.

The home appliance 1000 may operate according to a control command received from another home appliance, the user device 2a or the server 3a. For example, when the home appliance 1000 has won prior approval of the user to operate according to a control command of the server 3a even without a user input, the home appliance 1000 may operate according to the control command received from the server 3a. The control command received from the server 3a may include a control command input by the user through the user device 2a, a control command based on a preset condition or the like, without being limited thereto.

The user device 2a may transmit information about the user to the home appliance 1000 or the server 3a through the communication module. For example, the user device 2a may transmit information about a location of the user, a physical condition of the user, a preference of the user, a schedule of the user, or the like, to the server 3a. The user device 2a may transmit the information about the user to the server 3a according to prior approval of the user.

The home appliance 1000, the user device 2a or the server 3a may determine a control command by using a technology, such as artificial intelligence (AI). For example, the server 3a may receive information about the operation or status of the home appliance 1000 or information about the user of the user device 2a, process the information by using a technology, such as AI, and transmit a result of the processing or a control command to the home appliance 1000 or the user device 2a based on the result of the processing.

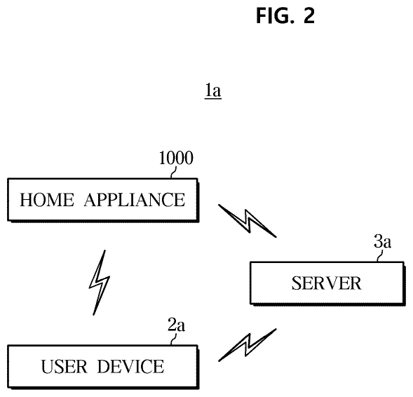

FIG. 2 is a block diagram of a home network system including home appliances, according to an embodiment of the disclosure.

Referring to FIG. 2, the home network system 1a is a system that builds an environment where the home appliances 1000 at home communicate with one another over a wired or wireless network and allow mutual access through the Internet to or from outside the home.

The home network system 1a may include the home appliance 1000 and the server 3a, and further include the user device 2a.

On receiving a command to perform a first diagnosis mode as a user input, the home appliance 1000 may control operations of a plurality of loads based on diagnosis control information.

The diagnosis control information may include control information for each of the plurality of loads.

When the load is a motor, the control information may include at least one of acceleration control, deceleration control, speed maintenance control, stop control, target rotation speed, maximum rotation speed, acceleration, or reference time for maintaining a rotation speed.

The home appliance 1000 may collect detection information detected from a plurality of sensors while performing the first diagnosis mode, and match and store the collected detection information of each of the plurality of sensors with control information for each of the plurality of loads.

The home appliance 1000 may store the detection information of each of the plurality of sensors as being matched with control information for each of the plurality of loads to correspond to a performance time of the first diagnosis mode.

The detection information of each of the plurality of sensors may include sound information about a sound generated from the home appliance.

The detection information of each of the plurality of sensors may include vibration information about a vibration generated from the home appliance.

The detection information of each of the plurality of sensors may include environment information about an operation environment of the home appliance. For example, the operation environment of the home appliance may include outside temperature, outside humidity, inside temperature, inside humidity, a water level of the home appliance, water temperature of the home appliance, whether the door is open or closed, or the like.

It is also possible that the home appliance 1000 controls the first diagnosis mode to be performed based on a preset cycle.

The home appliance 1000 may transmit the stored detection information of each of the plurality of sensors and control information for each of the plurality of loads to the server 3a while performing the first diagnosis mode.

The home appliance 1000 may receive diagnosis control information from the server 3a and store the received diagnosis control information. The diagnosis control information received from the server 3a may include diagnosis control information collected, trained, and then updated in the server 3a.

The diagnosis control information may include a diagnosis algorithm to diagnose a failure of the home appliance.

The home appliance 1000 may identify whether a command to perform a second diagnosis mode is received as a user input while controlling operation of at least one load, recognize control information for the at least one load based on the command to perform the second diagnosis mode being identified as being received, collect detection information detected by at least one sensor, and match and store the detection information detected by the at least one sensor and the control information for the at least one load.

The home appliance 1000 may match and transmit the detection information detected by the at least one sensor and the control information for the at least one load to the server 3a.

It is also possible that the home appliance 1000 performs the second diagnosis mode for a reference diagnosis time. In this case, the home appliance 1000 may collect the detection information detected by the at least one sensor for the reference diagnosis time for which the second diagnosis mode is performed, and recognize the control information for the at least one load for the reference diagnosis time.

When the home appliance is a clothes treating apparatus and the load is a driving motor, the control information for the driving motor may include at least one of an operation mode, acceleration control, deceleration control, speed maintenance control, stop control, target rotation speed, acceleration, or reference time for maintaining a rotation speed.

In the case that the home appliance is the clothes treating apparatus, the operation mode may include a laundry mode and a drying mode. The laundry mode may include at least one of a washing process, a rinsing process, an intermediate dehydrating process, a final dehydrating process, a draining process and a water supply process.

When the home appliance is an air conditioner, the operation mode may include at least one of a cooling mode, a heating mode and a dehumidifying mode.

The detection information of the at least one sensor may include sound information about a sound generated from the home appliance.

The detection information of the at least one sensor may include vibration information about a vibration generated from the home appliance.

The detection information of each of the plurality of sensors may include environment information about an operation environment of the home appliance. For example, the operation environment of the home appliance may include outside temperature, outside humidity, inside temperature, inside humidity, a water level of the home appliance, water temperature of the home appliance, whether the door is open or closed, or the like.

The home appliance 1000 may receive diagnosis result information from the server 3a and output the received diagnosis result information.

The home appliance 1000 may display the diagnosis result information received from the server 3a in an image or a voice.

It is also possible that the home appliance 1000 may diagnose a failure of the home appliance 1000 based on detection information of each of the plurality of sensors, control information for each of the plurality of loads and reference diagnosis information collected while performing the first diagnosis mode.

It is also possible that the home appliance 1000 may diagnose a failure of the home appliance based on detection information of at least one sensor, control information for at least one load and the reference diagnosis information collected while performing the second diagnosis mode.

It is also possible for the home appliance 1000 to communicate with the user device 2a and receive a command to perform the first diagnosis mode or a command to perform the second diagnosis command from the user device 2a.

When the home appliance 1000 is not equipped with any microphone, it is also possible for the home appliance 1000 to receive the sound information from the user device 2a based on completion of the first diagnosis mode. In this case, it is also possible that the home appliance 1000 matches the received sound information, detection information of each of the plurality of sensors and control information for each of the plurality of loads and transmits the matched information to the server 3a.

When the home appliance 1000 is not equipped with any vibration sensor, it is also possible for the home appliance 1000 to receive the vibration information from the user device 2a based on completion of the first diagnosis mode. In this case, it is also possible that the home appliance 1000 matches the received vibration information, detection information of each of the plurality of sensors and control information for each of the plurality of loads and transmits the matched information to the server 3a.

When the home appliance 1000 is not equipped with any vibration sensor, it is also possible for the home appliance 1000 to receive the vibration information from the user device 2a based on completion of the second diagnosis mode. In this case, it is also possible that the home appliance 1000 matches the received vibration information and control information for at least one load, and transmits the matched information to the server 3a.

It is also possible for the home appliance 1000 to receive diagnosis result information from the user device 2a and output the received diagnosis result information.

The home appliance 1000 may display the diagnosis result information received from the user device 2a in an image or a voice.

On receiving performance information of the first diagnosis mode, detection information of each of the plurality of sensors or control information for each of the plurality of loads from the home appliance 1000, the server 3a diagnoses a failure throughout the home appliance based on preset reference diagnosis information, the received detection information of each of the plurality of sensors or control information for each of the plurality of loads.

For example, the server 3a may diagnose abnormal noise from a fault of a load of the home appliance, a fastening error of the load, or an installation error of the home appliance based on information received from the home appliance. The server 3a may identify a cause of the abnormal noise and a cause of the fault of the load, and recognize the identified information as the diagnosis result information.

On receiving performance information of the second diagnosis mode, detection information of the at least one sensor, and control information for at least one load from the home appliance 1000, the server 3a may diagnose a failure related to operation of the at least one load based on preset reference diagnosis information, the received detection information of the at least one sensor and control information for the at least one load.

The server 3a may transmit the diagnosis result information about failure diagnosis for the home appliance to the home appliance 1000.

The server 3a may communicate with the user device 2a, and is also able to transmit the diagnosis result information about the failure diagnosis for the home appliance 1000 to the user device 2a.

The server 3a may train the diagnosis control information based on the control information for each of the plurality of loads, detection information of each of the plurality of sensors and diagnosis control information for the home appliance, update the diagnosis control information based on the trained information, and transmit the updated diagnosis control information to the home appliance 1000.

The user device 2a may communicate with the home appliance 1000 and the server 3a.

When receiving a command to perform the first diagnosis mode as a user input, the user device 2a may transmit the received command to perform the first diagnosis mode to the home appliance 1000, and when receiving a command to perform the second diagnosis mode as a user input, the user device 2a may transmit the received command to perform the second diagnosis mode to the home appliance 1000.

The user device 2a may receive a command to turn on or off the microphone as a user input, and collect sound information based on the command to turn on the microphone being received and transmit the collected sound information to the home appliance 1000 based on completion of the collecting of the sound information.

The user device 2a may collect the sound information of the home appliance through the microphone while performing the first diagnosis mode or the second diagnosis mode, and transmit the collected sound information to the home appliance 1000.

The user device 2a may collect the vibration information of the home appliance through the vibration sensor while performing the first diagnosis mode or the second diagnosis mode, and transmit the collected vibration information to the home appliance 1000.

On receiving the diagnosis result information from the server 3a, the user device 2a may output the received diagnosis result information. The user device 2a may transmit the received diagnosis result information to the home appliance 1000.

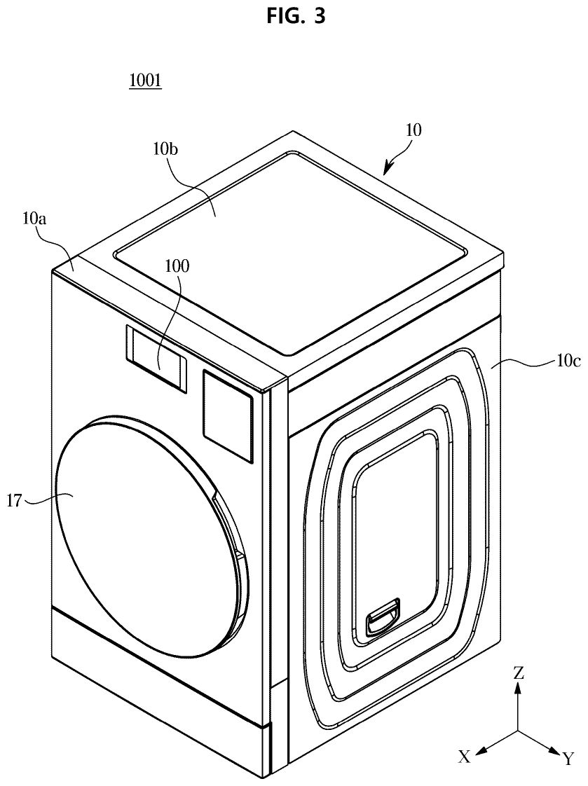

FIGS. 3 to 6 illustrate a home appliance according to various embodiments of the disclosure.

In the disclosure, described is a clothes treating apparatus for treating and/or managing clothes among the home appliances as an example. The clothes treating apparatus may include various devices, such as a washing machine, a dryer, a washing machine with drying function and a garment care system. In the disclosure, described is the washing machine with drying function as an example for the clothes treating apparatus.

FIG. 3 illustrates a clothes treating apparatus according to an embodiment of the disclosure.

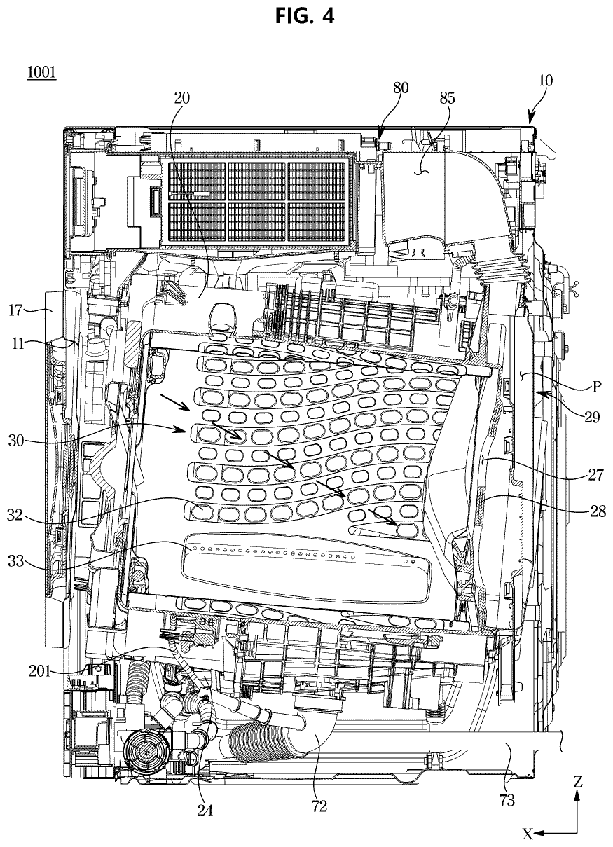

FIG. 4 is a cross-sectional view of a clothes treating apparatus according to an embodiment of the disclosure.

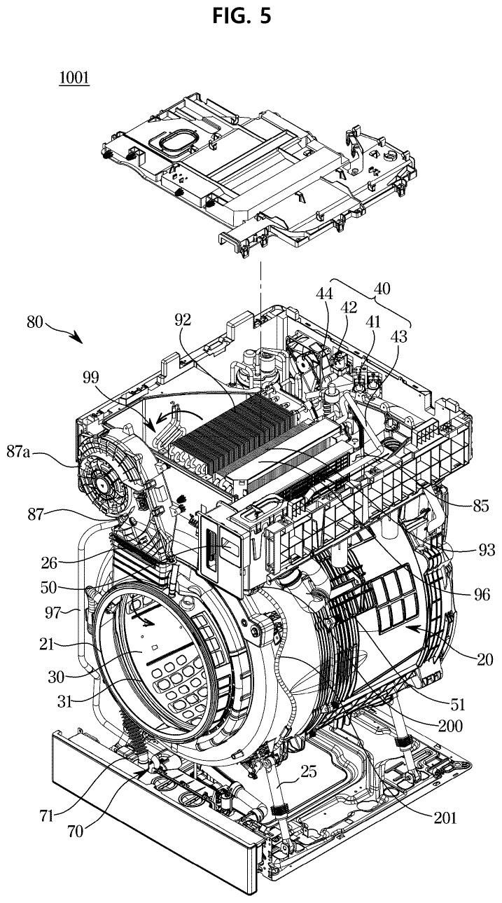

FIG. 5 illustrates an interior of a clothes treating apparatus according to an embodiment of the disclosure.

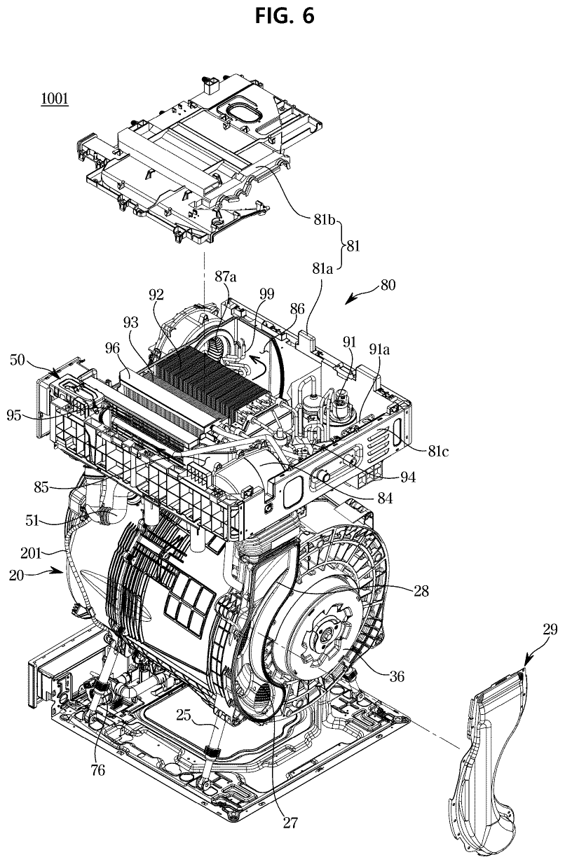

FIG. 6 is a diagram illustrating components arranged in a clothes treating apparatus viewed from a direction different from a direction of FIG. 5 according to an embodiment of the disclosure.

Referring to FIG. 3, a clothes treating apparatus 1001 may include a housing 10 that defines an exterior of the clothes treating apparatus 1001 and accommodates various components inside.

The housing 10 may be provided in the form of a box with a laundry inlet 11 formed on one side. The laundry inlet 11 may be arranged to face substantially forward.

The housing 10 may include a plurality of frames. For example, the housing 10 may include a front frame 10a, a top frame 10b, side frames 10c, a rear frame 10d (see FIG. 4) and a bottom frame. The plurality of frames may be provided to be coupled to each other. The plurality of frames may be coupled to form the housing 10. Alternatively, the plurality of frames may be integrally formed.

The clothes treating apparatus 1001 may include a door 17 to open or close the laundry inlet 11. The door 17 may be rotationally mounted on the housing 10 through a hinge. At least a portion of the door 17 may be transparent or translucent for the inside of the housing 10 to be seen. For example, the door 17 may include tempered glass.

The clothes treating apparatus 1001 may include a control panel 100 arranged on one side of the housing 10. The control panel 100 may include a user interface that allows the user to interact with the clothes treating apparatus 1001. The control panel may include at least one input module and at least one output module.

For example, the at least one input module may convert sensory information received from the user into an electric signal.

The at least one input module may include a power button, an operation button, a course selection dial (or a course selection button) and a washing/rinsing/dehydrating setting button.

The at least one input module may include a tact switch, a push switch, a slide switch, a toggle switch, a micro switch, a touch switch, a touch pad, a touch screen, a jog dial and/or a microphone.

The at least one output module may visually or acoustically provide the user with information relating to an operation of the clothes treating apparatus 1001. For example, the at least one output module may deliver information relating to an operation time of the clothes treating apparatus 1001 and the laundry course, and washing settings/rinsing settings/dehydration settings to the user. The information relating to the operation of the clothes treating apparatus 1001 may be output through a screen, an indicator, a voice, or the like.

The at least one output module may include a liquid crystal display (LCD) panel, a light emitting diode (LED) panel, a speaker, or the like.

Referring to FIGS. 4, 5, and 6, the clothes treating apparatus 1001 may include a tub 20 arranged in the housing 10 to accommodate water.

The tub 20 may be arranged in a substantially cylindrical shape with a tub opening 21 formed on one side. The tub opening 21 may be placed to correspond to the laundry inlet 11. The tub opening 21 may be arranged to face substantially forward. The tub opening 21 may be opened or closed by the door 17.

The tub 20 may be connected to the housing 10 by a damper 25. The damper 25 may absorb vibrations produced when a drum 30 is rotated, to dampen the vibrations carried to the housing 10.

The clothes treating apparatus 1001 may include the drum 30 that accommodates the laundry. The drum 30 may include a drum opening 31 through which to put in the laundry, and at least one lifter 33 to do the laundry by lifting and dropping the laundry.

The drum opening 31 may be arranged to correspond to the laundry inlet 11 and the tub opening 21. The drum opening 31 may be arranged to face substantially forward. The laundry may pass the laundry inlet 11, the tub opening 21 and the drum opening 31 in sequence to be accommodated in the drum 30 or taken out of the drum 30.

The drum 30 may be rotated in the tub 20 to perform an operation of a washing, rinsing and/or dehydrating process. Multiple through holes 32 may be arranged at the cylindrical wall of the drum 30. The multiple through holes 32 may function as flow paths through which the water stored in the tub 20 flows into the drum 30 or flows out of the drum 30.

The clothes treating apparatus 1001 may include a driving motor 36 for rotating the drum 30.

The driving motor 36 may deliver driving force generated from the driving motor to the drum 30 through a shaft that passes through the tub and connects to the drum.

The driving motor 36 may rotate the drum 30 forward or reverse to perform an operation of a washing, rinsing and/or dehydrating or drying process.

The clothes treating apparatus 1001 may include a water supply device 40 for supplying water supplied from an external water supply source to the tub 20.

The water supply device 40 may include water supply valves 41 and 42 to supply water or block supplying water. For example, the water supply valves 41 and 42 may include a first water supply valve 41 for supplying cold water and a second water supply valve 42 for supplying hot water.

The first water supply valve 41 may be referred to as a cold water valve. The second water supply valve 42 may be referred to as a hot water valve.

Furthermore, the water supply device 40 may include water supply tubes 43 and 44. The water supply tubes 43 and 44 may be provided as hoses of a flexible material, plastic tubes or metal tubes.

The water supply valves 41 and 42 may be arranged at the water supply tubes 43 and 44. For example, the water supply tubes 43 and 44 may include a first water supply tube 43 at which the first water supply valve 41 is arranged, and a second water supply tube 44 at which the second water supply valve 42 is arranged. The first water supply tube 43 may be referred to as a cold water tube. The second water supply tube 44 may be referred to as a hot water tube.

At least one of the water supply tubes 43 and 44 may guide water from the water supply valve 41 or 42 to the tub 20. At least one of the water supply tubes 43 and 44 may extend from the water supply valve 42 to the tub 20.

The water supply valve 41 or 42 may open or close the water supply tube 43 or 44. The water supply valve 41 or 42 may allow or block the supply of water to the tub 20 from the external water source. For example, the water supply valve 41 or 42 may include a solenoid valve that is opened or closed in response to an electric signal.

The clothes treating apparatus 1001 may include a detergent supplier 50 for supplying a detergent to the tub 20. The term detergent may encompass a detergent for prewashing, a detergent for main washing, a fabric softener, a bleaching agent, or the like.

The detergent supplier 50 may include a passive detergent supplier that allows the user to put in the detergent, or an automatic detergent supplier that automatically puts in a portion of pre-stored detergent.

The detergent supplier 50 may be connected to the tub 20 through a detergent connection tube 51. For example, the detergent supplier 50 may be arranged to supply a solid laundry detergent and/or softener to the tub 20. The type of the detergent is not, however, limited thereto.

The detergent connection tube 51 may be shaped like a letter ‘U’. The detergent connection tube 51 may be provided as hoses of a flexible material, plastic tubes or metal tubes. The detergent connection tube 51 may be connected to the detergent supplier 50 at one end and connected to the tub 20 at the other end.

The clothes treating apparatus 1001 may include a drain device 70 for draining the water accommodated in the tub 20 to the outside. The drain device 70 may include a drain pump 71 that pumps the water in the tub 20 and discharges the pumped water out of the housing 10.

The drain device 70 may be connected to the tub 20 through a tub connection tube 72. The drain device 70 may discharge the water in the tub 20 out of the housing 10 through a drain tube 73. The drain device 70 may further include a drain valve (not shown) arranged at the drain tube 73 to open or close the drain tube 73.

The drain valve may be arranged between the tub and the drain pump.

It is also possible that the clothes treating apparatus 1001 further includes a circulation pump 76 to pump the water out of the tub 20 and circulate the pumped water back into the tub 20.

The clothes treating apparatus 1001 may include a drying device 80 for drying the laundry accommodated in the drum 30.

The drying device 80 may dry and heat the air discharged from the tub 20, and circulate the dried and heated air into the tub 20 to dry the clothes in the drum 30. In various embodiments of the disclosure, the drying device 80 may be arranged on top of the tub 20.

To ensure an area where the heated air supplied into the drum 30 comes into contact with the laundry, a tub exhaust 27 may be arranged in an opposite location to the air inlet 26 through which the air heated by the drying device 80 is supplied to the tub 20.

In various embodiments of the disclosure, the clothes treating apparatus 1001 may further include an exhaust path P to move the air discharged from inside the tub 20 to the drying device 80. The exhaust path P may be arranged for the air discharged from the tub exhaust 27 to flow into an inflow path 85. The exhaust path P may be arranged to discharge humid air that has passed and come out of the tub 20. For example, the exhaust path P may be arranged in the back of the tub 20.

The air in the tub 20 may be discharged to a tub duct 28 through the tub exhaust 27 formed in the back of the tub 20. The air discharged to the tub duct 28 may flow along the exhaust path P to be supplied to the drying device 80.

In various embodiments of the disclosure, the clothes treating apparatus 1001 may include a duct cover 29 to form at least a portion of the exhaust path P. The duct cover 29 may be arranged to cover the open rear side of the tub duct 28. For example, the tub 20 may include the duct cover 29. The duct cover 29 may form at least a portion of the exhaust path P in which the air discharged through the tub exhaust 27 flows to the drying device 80.

The drying device 80 may include a dry case 81. The dry case 81 may include a dry base 81a, and a dry cover 81b coupled to the dry base 81a to form a flow path in which the air may be moved. The dry cover 81b may cover an open top of the dry base 81a.

Referring to FIG. 6, the drying device 80 may include a rear cover 81c to be coupled onto the rear side of the dry base 81a. The rear cover 81c may form at least a portion of the rear side of the drying device 80. The water supply valve 41 or 42 may be mounted on the rear cover 81c.

In the drying device 80, an inflow path 85 through which the air discharged from the tub 20 flows in, a heating path 86 for the air flowing into the drying device 80 through the inflow path 85 to exchange heat, and a supply path 87 for supplying the air that has exchanged heat while passing the heating path 86 to the tub 20 may be arranged.

The drying device may include an inflow guide 84 that guides the air discharged from the tub 20 to the inflow path 85. The inflow path 85 may be connected to the exhaust path P formed in the tub 20 through the inflow guide 84. The air that has passed the exhaust path P may flow into the inflow path 85 of the drying device 80 through the inflow guide 84.

A filter 95 may be arranged in the inflow path 85 to filter off foreign materials, such as lint contained in the air flowing in through the exhaust path P from the tub 20. The air flowing into the inflow path 85 may move to the heating path 86 after passing through the filter 95.

A heat exchanger 92 and 93 may be arranged in the heating path 86. The heat exchanger 92 and 93 may include a condenser 92 and an evaporator 93.

The supply path 87 may be connected to the heating path 86, and may extend downward to discharge the heated air to the opening of the tub 20. In other words, the supply path 87 may be arranged to supply the heated air back into the tub 20.

The drying device 80 may be provided in a heat pump type.

The drying device 80 may include a blower fan 87a arranged in the supply path 87, and a compressor 91, a condenser 92, an evaporator 93, an expansion valve and a refrigerant tube 94 arranged in the dry case 81, and may further include a cooling fan 91a for cooling the compressor 91.

The blower fan 87a may move air into the tub 20. In other words, the blower fan 87a may be arranged to apply air to the laundry in the drum 30. For example, the blower fan 87a may include a sirocco fan.

The compressor 91 may compress the refrigerant, and supply the compressed hot and high-pressure refrigerant to the condenser 92. The condenser 92 may heat the surrounding air by cooling the refrigerant. The heated air may flow into the drum 30 to dry the clothes.

The refrigerant that has expanded while going through the expansion valve may cool the surrounding air by absorbing heat in the evaporator 93. In other words, the evaporator 93 may remove the moisture by cooling hot and humid air that has passed through the drum 30. The air deprived of the moisture passes the condenser 92, and may be reheated by exchanging heat with the refrigerant passing the condenser 92. In other words, the condenser 92 may heat the air that has passed the evaporator 93. The condenser 92 and the evaporator 93 correspond to the heat exchanger. The condenser 92 may be referred to as a first heat exchanger. The evaporator 93 may be referred to as a second heat exchanger.

The drying device 80 may further include a drying heater 99. The drying heater 99 may increase dry efficiency of the drying device 80. The heat pump components of the drying device 80 may be replaced by the drying heater 99.

The drying heater 99 may heat the air flowing into the drying device 80. The drying heater 99 may be arranged in a heating path 86. The drying heater 99 may be placed farther downstream than the condenser 92 in a flow of the air passing through the drying device 80. Furthermore, the drying heater 99 may be provided in a relatively small size so as to minimize flow path resistance. For example, the drying heater 99 may be a sheath heater.

The drying device 80 may include a nozzle device 96 for cleaning the heat exchange 92 and 93. The nozzle device 96 may be arranged in the heating path 86. The nozzle device 96 may receive water from the water supply device 40 and spray the water toward the heat exchanger 92 and 93. The water sprayed from the nozzle device 96 may wash a side of the heat exchanger 92 and 93.

The clothes treating apparatus 1001 may include a drain line 97 for guiding the water discharged from the drying device 80 to the tub 20. The drain line 97 may be provided as hoses of a flexible material, plastic tubes or metal tubes. The drain line 97 may guide the condensate water produced from the heat exchanger 92 and 93 of the drying device 80 to the outside of the drying device 80. The drain line 97 may guide the water sprayed by the nozzle device 96 for cleaning the heat exchanger 92 and 93 to the outside of the drying device 80.

The drain line 97 may be connected to the drain device 70. The drain line 97 may be connected to the drain pump 71. The water discharged from the drying device 80 may flow along the drain line 97 to the drain device 70. The water brought into the drain device 70 through the drain line 97 may be guided to the tub 20. The condensate water brought into the tub 20 may be discharged out of the clothes treating apparatus 1001 according to operation of the drain pump 71.

The clothes treating apparatus 1001 may include a water heater 24. The water heater 24 may be equipped underneath the tub 20 to heat the water for doing the laundry.

Furthermore, in the drying process, the water supply device 40 may supply a certain amount of water to a lower side of the tub 20 through the exhaust path P, and the water heater 24 may heat the water supplied into the tub 20 through the water supply device 40, the exhaust path P and the tub exhaust 27 to generate steam. The steam generated by the water supply device 40 and the water heater 24 may come into contact with the clothes during the drying process, thereby preventing the clothes from being wrinkled as much as possible.

The clothes treating apparatus 1001 may include a water level sensor 200 for detecting the water level in the tub 20. The water level sensor 200 may be located outside the tub 20 and arranged in a connection hose 201 connected to the tub 20. The water level in the connection hose 201 may be equivalent to the water level in the tub 20. The location of the water level sensor 200 is not limited to what is illustrated herein.

A vibration sensor 220 may be further included to detect vibrations generated in the clothes treating apparatus 100.

The vibration sensor 220 may be, but not exclusively, a capacitive type microelectromechanical systems (MEMS) acceleration sensor, a piezoresistive type MEMS acceleration sensor, a resistive type vibration sensor, a capacitive type vibration sensor, an optical vibration sensor, a piezoelectric sensor, an ultrasonic sensor, or a gyro sensor.

Referring to FIGS. 3, 4, 5, and 6, the clothes treating apparatus 1001 is illustrated as a washing machine with drying function, but is not limited thereto. The clothes treating apparatus 1001 may correspond to a washing machine that does not include a drying device.

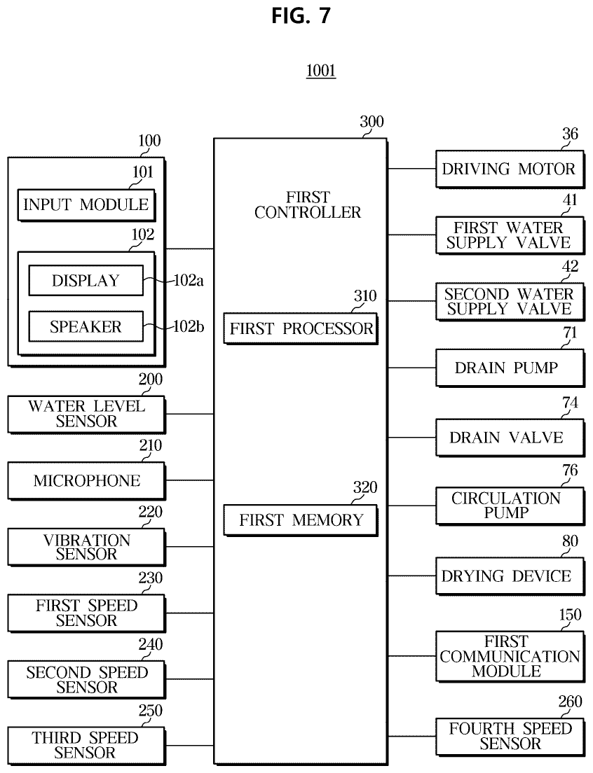

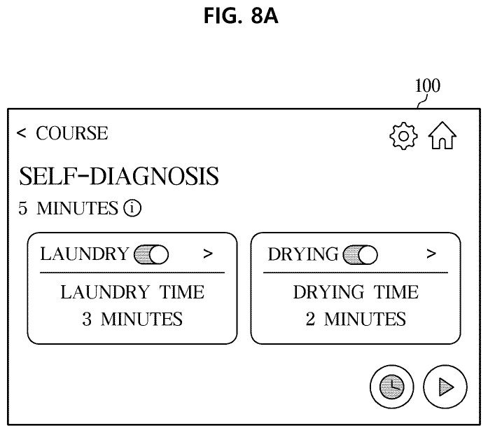

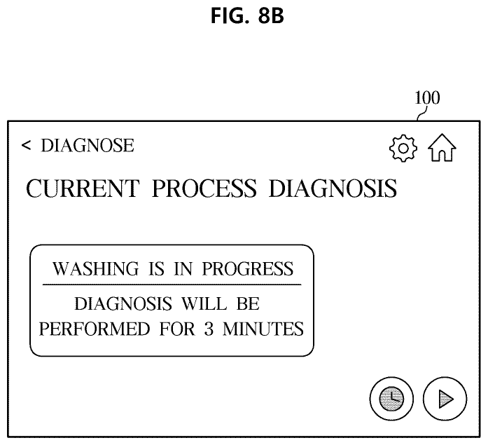

FIG. 7 is a control block diagram of a clothes treating apparatus according to an embodiment of the disclosure, which will be described in connection with FIGS. 8A, 8B, 9, and 10.

FIGS. 8A and 8B illustrate a control panel equipped in a clothes treating apparatus according to various embodiments of the disclosure.

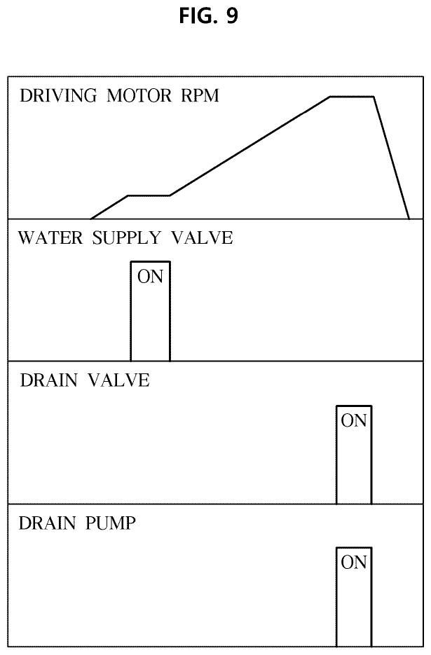

FIG. 9 illustrates control over a plurality of loads in a laundry mode during a first diagnosis mode of a clothes treating apparatus according to an embodiment of the disclosure.

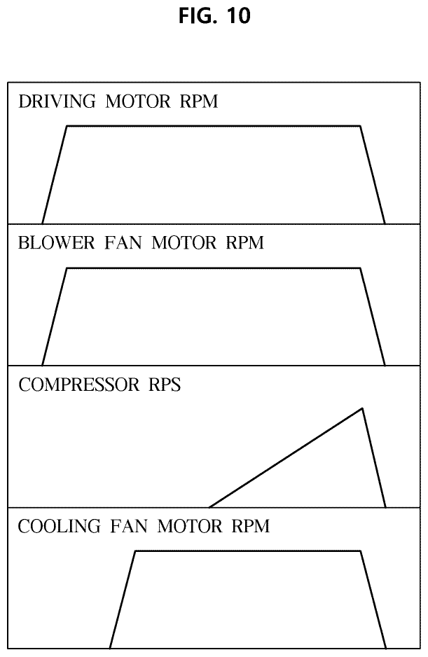

FIG. 10 illustrates control over a plurality of loads in a drying mode during a first diagnosis mode of a clothes treating apparatus according to an embodiment of the disclosure.

As a home appliance according to an embodiment of the disclosure, a washing machine with drying function will be taken as an example.

The clothes treating apparatus 1001 may include the driving motor 36, the water supply valves 41 and 42, the drain pump 71, the drain valve 74, the circulation pump 76, the control panel 100, a first communication module 150, a plurality of sensors 200, 210, 220, 230, 240, 250 and 260, the drying device 80 and a first controller 300.

The driving motor 36 may be rotated in a first direction, and in a second direction opposite to the first direction, and may be rotated at a rotation speed corresponding to a control command of the first controller 300.

The first direction may be a forward or clockwise direction. The second direction may be a reverse or counterclockwise direction.

The driving motor 36 may be connected to the drum 30 to deliver the rotational force to the drum 30.

The drum 30 may be rotated by being engaged with operation of the driving motor 36.

The drum 30 may be rotated in the first direction, and in the second direction opposite to the first direction, and may be rotated at a rotation speed corresponding to a rotation speed of the driving motor 36.

The water supply valves 41 and 42, the drain pump 71, the drain valve 74 and the circulation pump 76 are described above in connection with FIGS. 3 to 6, so the description thereof will not be repeated.

The drying device 80 may include a blower fan 87a for applying air to the laundry in the drum 30, the compressor 91 for compressing a refrigerant of the heat pump, and the cooling fan 91a for cooling the compressor 91.

The blower fan 87a may include a first motor for fan, and a first blade that rotates by the first motor.

The blower fan 87a may be rotated in the first direction, and in the second direction opposite to the first direction, and may be rotated at a rotation speed corresponding to a control command of the first controller 300.

The compressor 91 may include a motor for compressor.

The motor for compressor may be rotated at a rotation speed corresponding to a control command of the first controller 300. The rotation speed of the motor for compressor may correspond to an operation factor of the compressor.

The cooling fan 91a may include a second motor for fan, and a second blade that rotates by the second motor.

The cooling fan 91a may be rotated in the first direction, and in the second direction opposite to the first direction, and may be rotated at a rotation speed corresponding to a control command of the first controller 300.

The control panel 100 may receive a user input and output various information about the operation of the clothes treating apparatus 1001. The control panel 100 may include a user interface.

The control panel 100 may include an input module 101 and an output module 102.

The input module 101 receives a user input.

The input module 101 may receive at least one of a start command, a pause command, a stop command, a laundry course and optional information.

The laundry course may include standard washing, bedclothes washing, boiling, wool washing, towel washing, quick washing, or the like. The laundry course may further include a diagnosis course to diagnose a failure of the clothes treating apparatus. The diagnosis course may include a first diagnosis mode and a second diagnosis mode.

The optional information may include at least one of an amount of water, temperature of the water, a washing time of a washing process, the number of rinsing processes, intensity of a dehydrating process and a time of the dehydrating process. In a case that a drying process is available to the clothe treating apparatus, the optional information may further include a dryness level.

The input module 101 may receive a command to perform the first diagnosis mode and a command to perform the second diagnosis mode.

The input module 101 may include hardware devices, such as a switch, a pedal, a keyboard, a mouse, a track ball, various levers, a handle, a stick, or the like in addition to buttons and a jog dial.

Furthermore, the input module 101 may include a graphical user interface (GUI), such as a touch pad, i.e., a software device. The touch pad may be implemented with a touch screen panel (TSP), thus forming an interlayer structure with a display 102a.

The control panel 100 may be implemented as a touch screen panel, and may display an image related to the first diagnosis mode or the second diagnosis mode. The control panel 100 may display items that may be selected by the user while displaying the image related to the first diagnosis mode or the second diagnosis mode.

Referring to FIG. 8A, when displaying an image related to the first diagnosis mode based on the command to perform the first diagnosis mode being received, the control panel 100 may display a list of operation modes to be automatically diagnosed through the first diagnosis mode and diagnosis indication information for each operation mode. The diagnosis indication information may include a time required for diagnosis for each operation mode.

When there are a plurality of operation modes to be periodically diagnosed with the first diagnosis mode, the control panel 100 may receive an operation mode for the first diagnosis mode. It is also possible for the control panel 100 to transmit the received operation mode to the first controller 300.

For example, the plurality of operation modes to be periodically diagnosed with the first diagnosis mode may include a laundry mode and a drying mode.

Referring to FIG. 8B, when displaying an image related to the second diagnosis mode based on the command to perform the second diagnosis mode being received, the control panel 100 may display process information being currently performed and indication information relating to a diagnosis method.

The output module 102 outputs operation information of the clothes treating apparatus 1001.

The output module 102 may output diagnosis result information corresponding to the first diagnosis mode.

The output module 102 may output diagnosis result information corresponding to the second diagnosis mode.

The output module 102 may also output a state of communication with the user device 2a and a state of communication with the server 3a.

The output module 102 may include a display 102a and a speaker 102b.

The display 102a may display performance information and completion information of the first diagnosis mode, and performance information and completion information of the second diagnosis mode.

The performance information of the first diagnosis mode may include information relating to progress of the first diagnosis mode.

The performance information of the second diagnosis mode may include information relating to progress of the second diagnosis mode.

The display 102a may display diagnosis result information corresponding to the first diagnosis mode in an image.

The display 102a may also display indication information about an accuracy decline probability of the diagnosis result due to accommodation of the laundry while the first diagnosis mode is being performed.

The display 102a may also display information indicating to draw out the laundry while the first diagnosis mode is being performed.

The display 102a may display diagnosis result information corresponding to the second diagnosis mode in an image.

The display 102a may display operation information of the clothes treating apparatus 1001, a remaining time of the operation of the clothes treating apparatus 1001, and even a laundry course and option information selected by the user.

The display 102a may display indication information corresponding to an operation of the clothes treating apparatus 101 in text or an emoji.

The display 102a includes a plurality of 7-segments.

The display 102a may be provided as a liquid crystal display (LCD), a digital light processing (DLP) panel, a plasma display panel (PDP), an electro luminescence (EL) panel, an electrophoretic display (EPD) panel, an electrochromic display (ECD) panel, a light emitting diode (LED) panel, an organic light emitting diode (OLED) panel, or the like, but is not limited thereto.

The speaker 102b may output performance information and completion information of the first diagnosis mode in an indication sound, and performance information and completion information of the second diagnosis mode in an indication sound.

The speaker 102b may output the diagnosis result information corresponding to the first diagnosis mode in an indication sound.

The indication sound may include a notification sound, such as a beep sound, or a voice.

It is also possible that the speaker 102b outputs the indication information in a voice about an accuracy decline probability of the diagnosis result due to accommodation of laundry while the first diagnosis mode is being performed.

It is also possible for the speaker 102b to output an indication sound to draw out the laundry while the first diagnosis mode is being performed.

The speaker 102b may output the diagnosis result information corresponding to the second diagnosis mode in an indication sound.

The speaker 102b may output an indication sound corresponding to an operation, such as start, pause and stop of the clothes treating apparatus 1001.

The first communication module 150 may include various communication circuits for performing wired communication and/or wireless communication with an external device (e.g., a server, a user device and/or another home appliance).

The user device may include various electronic devices, such as a smart phone, a notebook computer, a laptop, a smart watch, a stationary tablet, or a speaker. The user input may be obtained not only through the control panel 100 but also through the user device.

The first communication module 150 may include at least one of a short-range communication circuit and a long-range communication circuit.

The first communication module 150 may transmit data to the external device or receive data from the external device. For example, the first communication module 150 may support cellular communication, a wireless local area network (WLAN), a home radio frequency (RF), infrared communication, ultra-wide band (UWB) communication, Wi-Fi, Wi-Fi Direct, Bluetooth, AD-HOC and/or Zigbee. Communication technologies supported by the first communication module 150 are not limited thereto.

The first communication module 150 may communicate with the external device through an access point (AP). The AP may connect a local area network (LAN) connected to the clothes treating apparatus 1001 to a wide area network (WAN) connected to the server. The clothes treating apparatus 1001 may be connected to the server through the WAN.

The first communication module 150 may transmit control information for each of the plurality loads and detection information of each of the plurality of sensors to the server 3a in response to a control command of the first controller 300.

The plurality of loads may include at least one of the driving motor 36, the water supply valves 41 and 42, the drain pump 71, the drain valve 74, the circulation pump 76, the blower fan 87a, the compressor 91 and the cooling fan 91a.

The plurality of sensors may include at least one of the water level sensor 200, the microphone 210, the vibration sensor 220, the first speed sensor 230, the second speed sensor 240, the third speed sensor 250 and the fourth speed sensor 260.

The first communication module 150 may transmit diagnosis result information received from the server 3a or the user device 2a to the first controller 300.

The first communication module 150 may transmit the command to perform the first diagnosis mode or the command to perform the second diagnosis mode received from the user device 2a.

The water level sensor 200 detects the height of the water accommodated in the tub 20, and transmits water height information (i.e., water level information) regarding the detected height to the first controller 300.

The microphone 210 is a sound-receiving sensor, which detects a sound generated from the clothes treating apparatus 1001 and transmits sound information about the detected sound to the first controller 300.

The microphone 210 may be arranged around the control panel 100.

There may be one or more microphones 210. The microphone 210 may be provided in an array type.

When there are two microphones equipped in the clothes treating apparatus, the two microphones may be placed at a preset distance from each other around the control panel 100.

The vibration sensor 220 detects vibration generated from the clothes treating apparatus 1001 and transmits vibration information about the detected vibration to the first controller 300.

The first speed sensor 230 detects a rotation speed of the driving motor 36 and transmits first rotation speed information about the detected rotation speed to the first controller 300.

The second speed sensor 240 detects a rotation speed of the motor for compressor equipped in the compressor 91 and transmits second rotation speed information about the detected rotation speed to the first controller 300.

It is also possible that the first speed sensor 230 includes a hall sensor for detecting the location of the rotor of the driving motor 36.

It is also possible that the second speed sensor 240 includes a hall sensor for detecting the location of the motor for compressor.

The third speed sensor 250 detects a rotation speed of the first motor equipped in the blower fan 87a and transmits third rotation speed information about the detected rotation speed to the first controller 300.

The fourth speed sensor 260 detects a rotation speed of the second motor equipped in the cooling fan 91a and transmits fourth rotation speed information about the detected rotation speed to the first controller 300.

It is also possible that the clothes treating apparatus further includes a first current sensor for detecting a current flowing to the driving motor 36 and a second current sensor for detecting a current flowing to the motor for compressor equipped in the compressor 91.

The clothes treating apparatus may further include a temperature sensor (not shown) for detecting temperature of the water in the tub. The clothes treating apparatus may further include a humidity sensor (not shown) for detecting humidity in the tub.

The first controller 300 may be electrically connected to various parts and/or devices of the clothes treating apparatus 1001 to control the various parts and/or devices. In other words, the first controller 300 controls general operation of the clothes treating apparatus 100.

The first controller 300 may control an operation of the clothes treating apparatus 1001 based on a user input received through the input module 101.

The first controller 300 may control the output module 102 to output operation information relating to the operation of the clothes treating apparatus 1001. The first controller 300 may control at least one of the display 102a and the speaker 102b.

The first controller 300 may receive a command to perform the first diagnosis mode or the second diagnosis mode from the input module 101.

It is also possible for the first controller 300 to receive the command to perform the first diagnosis mode or the second diagnosis mode from the user device 2a.

The first controller 300 may control the first diagnosis mode to be performed based on a preset cycle.

The first diagnosis mode is to periodically diagnose a failure of the clothes treating apparatus automatically. The first diagnosis mode may be to diagnose a failure of the plurality of operation modes performed in the clothes treating apparatus. The plurality of operation modes may include a laundry mode and a drying mode.

When the clothes treating apparatus is a washing machine, the operation mode may include only the laundry mode. When the clothes treating apparatus is a dryer, the operation mode may include only the drying mode.

The second diagnosis mode is to diagnose a failure related to a process being currently performed in response to the user's selection. For example, the second diagnosis mode is to diagnose a failure related to a process being performed based on a command to perform the second diagnosis mode being received while the one of the washing process, the water supply process, the dehydrating process, the draining process and the drying process is being performed.

On receiving the command to perform the first diagnosis mode from the input module 101, the first controller 300 may control operations of the plurality of loads based on the diagnosis control information.

When the laundry mode is included in the operation modes to be diagnosed using the first diagnosis mode, the plurality of loads may include the driving motor 36, the water supply valves 41 and 42, the drain pump 71, the drain valve 74 and the circulation pump 76.

When the drying mode is included in the operation modes to be diagnosed using the first diagnosis mode, the plurality of loads may include the blower fan 87a, the compressor 91 and the cooling fan 91a.

When the laundry mode and the drying mode are included in the operation modes to be diagnosed using the first diagnosis mode, the plurality of loads may include the driving motor 36, the water supply valves 41 and 42, the drain pump 71, the drain valve 74, the circulation pump 76, the blower fan 87a, the compressor 91 and the cooling fan 91a.

A control configuration of the first controller 300 for controlling the first diagnosis mode to be performed will now be described below.

When the laundry mode is included in the operation modes to be diagnosed using the first diagnosis mode, the first controller 300 may control a washing process, a water supply process, a dehydrating process and a draining process based on a command to perform the first diagnosis mode being received, and may also control a circulation process. This will be described with reference to FIG. 9.

In controlling the washing process, the first controller 300 controls acceleration of the driving motor 36 for the first time, and controls the rotation speed of the driving motor 36 to be maintained at a first target rotation speed for a first reference time in response to the rotation speed of the driving motor 36 reaching the first target rotation speed.

The first target rotation speed may be a speed at which the laundry sticks to the inner surface of the drum 30.

The first target rotation speed is about 100 rpm, but is not limited thereto.

The first reference time may be about 10 seconds, but is not limited thereto.

The first controller 300 may control the driving motor 36 to speed up at a preset speed until the rotation speed detected by the first speed sensor 230 reaches the first target rotation speed.

The preset speed is an acceleration of about 9.3 rpm/s.

The first controller 300 identifies whether the internal state of the drum 30 corresponds to an unloaded state while controlling the rotation speed of the driving motor 36 to be maintained at the first target rotation speed.

When the rotation speed of the driving motor 36 is the first target rotation speed, the first controller 300 may identify whether the internal state of the drum 30 corresponds to the unloaded state based on current information detected by the first current sensor and reference current information.

The first controller 300 may control the output module 102 to output indication information indicating an accuracy decline probability of failure diagnosis due to the laundry based on the internal state of the drum 30 being identified as a loaded state.

The first controller 300 may control the driving motor 36 to be stopped from rotation in response to opening of the door 17 being detected by a door open/close sensor (not shown). The first controller 300 may recognize that the internal state of the drum 30 is changed to the unloaded state from the loaded state in response to opening of the door 17 being detected by the door open/close sensor.

The first controller 300 may control the driving motor 36 to speed up again in response to the door 17 being recognized as being changed from the open state to the closed state based on open/close information of the door received from the door open/close sensor, and control the rotation speed of the driving motor 36 to be maintained at the first target rotation speed for the first reference time in response to the rotation speed of the driving motor 36 reaching the first target rotation speed.

The first controller 300 may count a first time from when the rotation speed of the driving motor 36 reaches the first target rotation speed.

The first controller 300 may control the water supply process based on the internal state of the drum 30 being recognized as the unloaded state.

The first controller 300 may control the first water supply valve 41 to be opened while the rotation speed of the driving motor 36 is maintained at the first target rotation speed, and control the first water supply valve 41 to be closed in response to the counted first time reaching the first reference time.

It is also possible that the first controller 300 identifies whether the water level in the tub is a reference water level based on the water level information received from the water level sensor 200 and controls the first water supply valve 41 to be closed based on the water level in the tub being identified as the reference water level.

The first controller 300 may control the second water supply valve 42 to be opened while the rotation speed of the driving motor 36 is maintained at the first target rotation speed, and control the second water supply valve 42 to be closed in response to the counted first time reaching the first reference time.

It is also possible that the first controller 300 identifies whether the water level in the tub is a reference water level based on the water level information received from the water level sensor 200 and controls the second water supply valve 42 to be closed based on the water level in the tub being identified as the reference water level.

The first controller 300 may control the dehydrating process based on completion of the water supply process.

In controlling the dehydrating process, the first controller 300 may control the driving motor 36 to speed up for the second time. The first controller 300 may control the driving motor 36 to speed up until the rotation speed of the driving motor 36 reaches the second target rotation speed.

The second target rotation speed corresponds to the highest rotation speed in the dehydrating process including about 1200 rpm, but is not limited thereto.

The first controller 300 may control the driving motor 36 to speed up at preset speed until the rotation speed detected by the first speed sensor 230 reaches the second target rotation speed.

The preset speed is an acceleration of about 9.3 rpm/s, but is not limited thereto.

In response to the rotation speed of the driving motor 36 reaching the second target rotation speed, the first controller 300 may control the rotation speed of the driving motor 36 to be maintained at the second target rotation speed, and control the draining process.

In controlling the draining process, the first controller 300 may control the drain valve 74 to be opened and the drain pump 71 to be turned on.

The first controller 300 may count a second time from when the rotation speed of the driving motor 36 reaches the second target rotation speed, control the rotation speed of the driving motor 36 to be maintained at the second target rotation speed until the counted second time reaches the second reference time, and control the draining process.

The second reference time may be about 120 seconds.

In response to the counted second time reaching the second reference time, the first controller 300 controls the rotation speed of the driving motor 36 to speed down, and controls the drain valve 74 to be closed and the drain pump 71 to be turned off.

The first controller 300 may control the driving motor 36 to speed down for a third reference time. Specifically, the first controller 300 may control the driving motor 36 to be stopped after a lapse of the third reference time from when the driving motor 36 starts to speed down.

The third reference time may be about 70 seconds.

It is also possible that the first controller 300 controls the circulation pump 76 to be turned on for a certain time based on completion of the water supply process, controls the circulation pump 76 to be turned off after a lapse of the certain time from when the circulation pump starts to be turned on, and controls the dehydrating process.

The first controller 300 may collect sound information received through the microphone 210 while performing the laundry mode in the first diagnosis mode, and match and store the collected sound information and control information for the loads. The first controller 300 may match and store the sound information and control information for the loads regarding performance of the laundry mode collected in time sequence.

The first controller 300 may collect vibration information received through the vibration sensor 220 while performing the laundry mode in the first diagnosis mode, and match and store the collected vibration information and control information for the loads. The first controller 300 may match and store the vibration information and control information for the loads regarding performance of the laundry mode collected in time sequence.

The first controller 300 may match and store the sound information, the vibration information and control information for the loads regarding performance of the laundry mode collected in time sequence.

The first controller 300 may transmit, to the server 3a, the control information for the plurality of loads and the detection information of the plurality of sensors stored while performing the laundry mode in the first diagnosis mode.

The control information for the plurality of loads may include open control information for the first and second water supply valves 41 and 42, close control information for the first and second water supply valves 41 and 42, acceleration control information for the driving motor 36, deceleration control information for the driving motor 36, rotation speed maintenance control information for the driving motor 36, open control information for the drain valve 74, close control information for the drain valve 74, on control information for the drain pump 71, off control information for the drain pump 71, on control information for the circulation pump 76 and off control information for the circulation pump 76.

The detection information of the plurality of sensors may include at least one of sound information detected through the microphone 210 and vibration information detected through the vibration sensor 220.

The sound information detected through the microphone 210 may include information about a sound generated from the driving motor that is being accelerated for the first time, information about a sound generated from the driving motor that is being maintained at the first target rotation speed, information about a sound generated from the driving motor that is being accelerated for the second time, information about a sound generated from the driving motor that is being maintained at the second target rotation speed and information about a sound generated from the driving motor being decelerated.

The sound information detected through the microphone 210 may further include sound information relating to the water supply process while the water supply valve is being opened, sound information relating to the draining process while the drain valve is being opened and the drain pump is being turned on, and sound information relating to the circulation process while the circulation pump is being turned on.

The vibration information detected through the vibration sensor 220 may include information about a vibration generated by rotation of the driving motor that is being accelerated for the first time, information about a vibration generated by rotation of the driving motor that is being maintained at the first target rotation speed, information about a vibration generated by rotation of the driving motor that is being accelerated for the second time, information about a vibration generated by rotation of the driving motor that is being maintained at the second target rotation speed and information about a vibration generated by rotation of the driving motor being decelerated.

The vibration information detected through the vibration sensor 220 may further include vibration information relating to the water supply process while the water supply valve is being opened, vibration information relating to the draining process while the drain valve is being opened and the drain pump is being turned on, and vibration information relating to the circulation process while the circulation pump is being turned on.

When the drying mode is included in the operation modes to be diagnosed using the first diagnosis mode, the first controller 300 may control the drying process based on a command to perform the first diagnosis mode being received, recognize control information for the plurality of loads during the drying process, and match and transmit the detection information detected by the plurality of sensors and the recognized control information for the plurality of loads to the server 3a. This will be described with reference to FIG. 10.

The first controller 300 may control the driving motor 36 to be accelerated and the first motor of the blower fan 87a to be accelerated.

The first controller 300 may control the driving motor 36 to be accelerated up to a third target rotation speed and the blower fan 87a to be accelerated up to a first maximum rotation speed.

The first controller 300 may recognize the rotation speed of the driving motor 36 based on the rotation speed information received from the first speed sensor 230, and control the driving motor 36 to maintain the rotation speed of the driving motor 36 at the third target rotation speed based on the rotation speed of the driving motor 36 being the third target rotation speed.

The first controller 300 may recognize whether the rotation speed of the first motor is the first maximum rotation speed based on rotation speed information of the first motor received from the third speed sensor 250, and control the first motor to maintain the rotation speed of the first motor at the first maximum rotation speed based on the rotation speed of the first motor being the first maximum rotation speed.

The first controller 300 may control the rotation speed of the driving motor 36 to be maintained at the third target rotation speed until the end of the drying process, and control the driving motor and the first motor to maintain the rotation speed of the first motor of the blower fan 87a at the first maximum rotation speed.

The third target rotation speed may be a maximum rotation speed of the driving motor 36 during the drying process.

The first controller 300 may count a third time from when acceleration control over the driving motor 36 and the blower fan 87a is started, and control the second motor of the cooling fan 91a to be accelerated in response to the counted third time reaching a fourth reference period.

The first controller 300 may control the second motor to be accelerated until the rotation speed of the second motor of the cooling fan 91a reaches the second maximum rotation speed.

The first controller 300 may recognize whether the rotation speed of the second motor is the second maximum rotation speed based on rotation speed information of the second motor received from the fourth speed sensor 260, and control the second motor to maintain the rotation speed of the second motor at the second maximum rotation speed based on the rotation speed of the second motor being the second maximum rotation speed.

The first controller 300 may control the second motor to maintain the rotation speed of the second motor at the second maximum rotation speed until the end of the drying process.

The first controller 300 may count a fourth time from when acceleration control over the second motor of the cooling fan 91a is started, and control the operation of the compressor 91 in response to the counted fourth time reaching a fifth reference time.

In controlling the operation of the compressor 91, the first controller 300 may control the motor for compressor equipped in the compressor 91 until the rotation speed of the motor for compressor reaches the fourth target rotation speed.

The first controller 300 may recognize whether the rotation speed of the motor for compressor is the fourth target rotation speed based on the rotation speed information detected by the second speed sensor 240, and control the motor for compressor to be decelerated based on the rotation speed of the motor for compressor being the fourth target rotation speed.

The fourth target rotation speed may be a maximum rotation speed of the motor for compressor, which may be about 60 rps.

It is also possible for the first controller 300 to control the driving motor 36, the first motor of the blower fan 87a and the second motor of the cooling fan 91a to be decelerated based on the deceleration control over the motor for compressor.

It is also possible for the first controller 300 to control the driving motor 36, the first motor of the blower fan 87a and the second motor of the cooling fan 91a to be stopped based on the deceleration control over the motor for compressor.

The first controller 300 may collect sound information received through the microphone 210 while performing the drying mode in the first diagnosis mode, and match and store the collected sound information and control information for the plurality of loads. The first controller 300 may match and store the sound information and control information for the plurality of loads regarding performance of the drying mode collected in time sequence.

The first controller 300 may collect vibration information received through the vibration sensor 220 while performing the drying mode in the first diagnosis mode, and match and store the collected vibration information and control information for the plurality of loads. The first controller 300 may match and store the vibration information and control information for the plurality of loads regarding performance of the drying mode collected in time sequence.

The first controller 300 may match and store the sound information, the vibration information and control information for the loads regarding performance of the drying mode collected in time sequence.

The first controller 300 may transmit the control information for the plurality of loads and the detection information of the plurality of sensors stored while performing the drying mode in the first diagnosis mode to the server 3a.

The control information for the plurality of loads may include acceleration control information for the driving motor 36, rotation speed maintenance control information for the driving motor 36, acceleration control information for the first motor of the blower fan 87a, rotation speed maintenance control information for the first motor of the blower fan 87a, acceleration control information for the second motor of the cooling fan 91a, rotation speed maintenance control information for the second motor of the cooling fan 91a, turn-on control information for the compressor 91 and turn-off control information for the compressor 91.

The detection information of the plurality of sensors may include at least one of sound information detected through the microphone 210 and vibration information detected through the vibration sensor 220.

The sound information detected through the microphone 210 may include information about a sound generated during acceleration of the driving motor 36, information about a sound generated during maintenance of the rotation speed of the driving motor 36, information about a sound generated during acceleration of the blower fan 87a, information about a sound generated during maintenance of rotation speed of the blower fan 87a, information about a sound generated during acceleration of the cooling fan 91a, information about a sound generated during maintenance of rotation speed of the cooling fan 91a, information about a sound generated during turn-on operation of the compressor 91 and information about a sound generated during turn-off of the compressor 91.

The vibration information detected through the vibration sensor 220 may include information about vibration generated by acceleration of the driving motor 36, information about vibration generated by maintenance of the rotation speed of the driving motor 36, information about vibration generated by acceleration of the blower fan 87a, information about vibration generated by maintenance of rotation speed of the blower fan 87a, information about vibration generated by acceleration of the cooling fan 91a, information about vibration generated by maintenance of rotation speed of the cooling fan 91a, information about vibration generated by turn-on operation of the compressor 91 and information about vibration generated by turn-off operation of the compressor 91.

In response to diagnosis result information of the first diagnosis mode being received from the server 3a after the performance information of the first diagnosis mode, control information for the plurality of loads and the detection information of the plurality of sensors are transmitted to the server 3a, the first controller 300 may control the output module 102 to output the received diagnosis result information of the first diagnosis mode.

In response to diagnosis result information of the first diagnosis mode being received from the user device 2a after the performance information of the first diagnosis mode, control information for the plurality of loads and the detection information of the plurality of sensors are transmitted to the server 3a, the first controller 300 may also control the output module 102 to output the received diagnosis result information of the first diagnosis mode.

It is also possible that the first controller 300 controls the output module 102 to output information requesting to check the diagnosis result information through the user device 2a after transmitting, to the server 3a, the performance information of the first diagnosis mode, control information for the plurality of loads and the detection information of the plurality of sensors.

Based on a command to perform the second diagnosis mode being received, the first controller 300 may recognize current process information, collect sound information received by the microphone 210, and collect vibration information received by the vibration sensor 220.

The first controller 300 may collect the sound information and the vibration information for a preset reference diagnosis time.

The first controller 300 may match and store the recognized current process information, the sound information received by the microphone 210 and the vibration information received by the vibration sensor 220.

The first controller 300 may match and transmit the recognized current process information, the sound information received by the microphone 210 and the vibration information received by the vibration sensor 220 to the server 3a.

For example, based on the recognized current process information being the water supply process, the first controller 300 may recognize water level information detected by the water level sensor 200, match and store the recognized water level information, the sound information received by the microphone 210 and the vibration information received by the vibration sensor 220, and transmit the current process information, the water level information, the sound information and the vibration information to the server 3a.

In another example, based on the recognized current process information being the dehydrating process, the first controller 300 may match and store the rotation speed information detected by the first speed sensor 230, the sound information received by the microphone 210 and the vibration information received by the vibration sensor 220, and transmit the current process information, the rotation speed information of the driving motor, the sound information and the vibration information to the server 3a.

In another example, based on the recognized current process information being the draining process, the first controller 300 may match and store open/close information of the drain valve, on/off information of the drain pump, the sound information received by the microphone 210 and the vibration information received by the vibration sensor 220, and transmit the current process information, the open/close information of the drain valve, the on/off information of the drain pump, the sound information and the vibration information to the server 3a.

In another example, based on the recognized current process information being the drying process, the first controller 300 may match and store the rotation speed information of the driving motor, the rotation speed information of the blower fan, the rotation speed information of the cooling fan and the rotation speed information of the compressor, the sound information received by the microphone 210 and the vibration information received by the vibration sensor 220, and transmit the current process information, the rotation speed information of the driving motor, the rotation speed information of the blower fan, the rotation speed information of the cooling fan and the rotation speed information of the compressor, the sound information and the vibration information to the server 3a.

In controlling output of the received diagnosis result information, the first controller 300 may control the display to display the received diagnosis result information in an image or control the speaker to output the received diagnosis result information in a voice.

The first controller 300 may control the output module 102 to output indication information relating to termination of performance of the first diagnosis mode and termination of performance of the second diagnosis mode.

The first controller 300 may control service request for the home appliance based on the diagnosis result information, or recognize failure response information corresponding to the diagnosis result information based on information stored in the first memory and control the output module 102 to output the recognized failure response information.

When the microphone 210 is not equipped in the clothes treating apparatus, the first controller 300 may match sound information received from the user device 2a with the detection information of each of the plurality of sensors and control information for each of the plurality of loads, store the matched information, and transmit the matched information to the server 3a.

When the vibration sensor 220 is not equipped in the clothes treating apparatus, the first controller 300 may match vibration information received from the user device 2a with the detection information of each of the plurality of sensors and control information for each of the plurality of loads, store the matched information, and transmit the matched information to the server 3a.

The first controller 300 may include at least one first processor 310 for controlling operation of the clothes treating apparatus 1001, and at least one first memory 320 for storing a program and data for controlling the operation of the clothes treating apparatus 1001.

The at least one first processor 310 may include at least one memory for storing data in the form of a program and an algorithm for controlling operations of components in the clothes treating apparatus 1001, and one or more processor chips or one or more processing cores for performing the aforementioned operations by using the data stored in the at least one memory.

The at least one first processor 310 may process various data and various signals based on instructions, data, a program and/or software stored in the first memory 320.

The at least one first processor 310 may include one or more of a central processing unit (CPU), a graphics processing unit (GPU), an accelerated processing unit (APU), a many-integrated-core (MIC), a digital signal processor (DSP), a neural processing unit (NPU), a hardware accelerator or a machine learning accelerator.

The first memory 320 stores diagnosis control information. It is also possible for the first memory 320 to update the diagnosis control information.

The diagnosis control information may include information about the first target rotation speed, the second target rotation speed, the first reference time, the second reference time and the third reference time involved with diagnosing the driving motor.

The diagnosis control information may further include information about acceleration of the driving motor.

The diagnosis control information may include information about the third target rotation speed, the fourth target rotation speed, the first maximum rotation speed, the second maximum rotation speed, the fourth reference time, the fifth reference time and the performance time of the drying process involved with diagnosing the driving motor, the compressor, the blower fan and the cooling fan.

The first memory 320 may store the failure response information corresponding to the diagnosis result information.

The first memory 320 may store data required for various embodiments.

The first memory 320 may be implemented in the form of memory embedded in or detachable from the clothes treating apparatus 1001 depending on the data storage use. For example, data for operating the clothes treating apparatus 1001 may be stored in the memory embedded in the clothes treating apparatus 1001 and data for an extended function of the clothes treating apparatus 1001 may be stored in the memory detachable from the clothes treating apparatus 1001.

In the meantime, the memory embedded in the clothes treating apparatus 1001 may be implemented with at least one of volatile memory (e.g., dynamic random access memory (DRAM), static RAM (SRAM), or synchronous dynamic RAM (SDRAM), or the like) or non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive or solid state drive (SSD)).

The memory detachable from the clothes treating apparatus 1001 may be implemented in such a format as memory card (e.g., compact flash (CF), secure digital (SD), micro-SD, mini-SD, extreme digital (xD), multi-media card (MMC), or the like) or external memory (e.g., USB memory) connectable to a USB port, without being limited thereto.

The memory 320 may include one, two or more memory chips or one, two or more memory blocks.

At least one component may be added to or omitted from the clothes treating apparatus 1001 to correspond to the performance of the clothes treating apparatus 1001 as shown in FIG. 7. Furthermore, it will be obvious to those of ordinary skill in the art that the relative positions of the components may be changed to correspond to the performance or structure of the clothes treating apparatus 1001.

The components shown in FIG. 7 may refer to software, or hardware components, such as field programmable gate arrays (FPGAs) and application specific integrated circuits (ASICs).

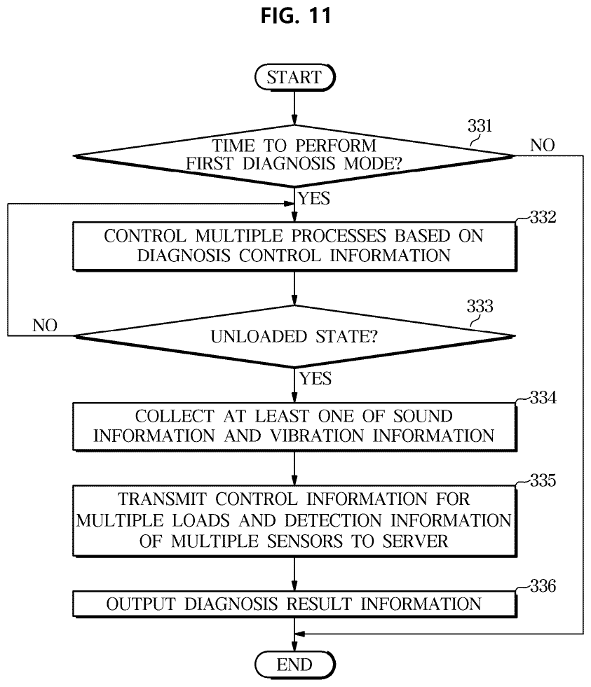

FIG. 11 is a control flowchart of a first diagnosis mode of clothes treating apparatus according to an embodiment of the disclosure.

Referring to FIG. 11, the clothes treating apparatus recognizes based on a diagnosis cycle stored in the first memory 320 whether the current time is to perform the first diagnosis mode to diagnose a failure in the first diagnosis mode, in operation 331.

The clothes treating apparatus may display information about the start to perform the first diagnosis mode through the output module 102 of the control panel based on the current time being recognized as time to perform the first diagnosis mode.

In addition, when receiving a command to perform the first diagnosis mode through the input module 101 of the control panel, the clothes treating apparatus may recognize that it is time to perform the first diagnosis mode.

It is also possible that the clothes treating apparatus recognizes that it is time to perform the first diagnosis mode when receiving a command to perform the first diagnosis mode from the user device 2a.

The clothes treating apparatus may control a plurality of processes based on the diagnosis control information when recognizing that it is time to perform the first diagnosis mode, in operation 332.

The plurality of processes may include the washing process, the water supply process, the dehydrating process, and the draining process, and may further include the circulation process and the drying process.

The controlling of the plurality of processes may include controlling operations of the plurality of loads. Specifically, the clothes treating apparatus may include controlling operations of the plurality of loads based on the diagnosis control information at a time to perform the first diagnosis mode.

The controlling of the operations of the plurality of loads based on the diagnosis control information may include controlling operations of the driving motor 36, the water supply valves 41 and 42, the drain pump 71, the drain valve 74 and the circulation pump 76.

The controlling of the operations of the plurality of loads based on the diagnosis control information may further include controlling operations of the blower fan 87a, the compressor 91 and the cooling fan 91a.

How to control the operations of the plurality of loads will be described below.

The clothes treating apparatus controls the driving motor 36 to be accelerated for the first time when the first diagnosis mode starts to be performed.

While controlling the driving motor 36 to be accelerated, the clothes treating apparatus recognizes whether the rotation speed of the driving motor reaches the first target rotation speed based on the rotation speed information detected by the first speed sensor 230, and controls the rotation speed of the driving motor 36 to be maintained at the first target rotation speed for the first reference time when recognizing that the rotation speed of the driving motor 36 reaches the first target rotation speed.

The clothes treating apparatus identifies whether the internal state of the drum 30 corresponds to an unloaded state while controlling the rotation speed of the driving motor 36 to be maintained at the first target rotation speed, in operation 333.

The identifying whether the internal state of the drum 30 corresponds to the unloaded state may include, when the rotation speed of the driving motor 36 is the first target rotation speed, identifying whether the internal state of the drum 30 corresponds to the unloaded state based on current information of the driving motor detected by the first current sensor and reference current information.

The clothes treating apparatus may output, through the output module 102, indication information indicating an accuracy decline probability of failure diagnosis due to the laundry based on the internal state of the drum 30 being identified as a loaded state.

The clothes treating apparatus may recognize whether the door 17 is in an open state based on door open/close information received from a door open/close sensor (not shown), and control the driving motor 36 to be stopped from rotation based on the door being recognized as in the open state. In this case, the clothes treating apparatus may recognize that the laundry has been drawn out of the drum.

The clothes treating apparatus may recognize whether the door 17 has been changed from the open state to a closed state based on the door open/close information received from the door open/close sensor (not shown), and control the driving motor 36 to be accelerated again based on the door 17 being recognized as having been changed from the open state to the closed state.

The clothes treating apparatus may recognize whether the rotation speed of the driving motor 36 reaches the first target rotation speed based on the rotation speed information detected by the first speed sensor 230, and control the rotation speed of the driving motor 36 to be maintained at the first target rotation speed for the first reference time based on the rotation speed of the driving motor 36 being recognized as reaching the first target rotation speed.

It is also possible that the clothes treating apparatus transmits, to the server 3a, state information about a load state in the drum based on the door open/close information being not received from the door open/close sensor. Specifically, in transmitting the control information for the plurality of loads and the detection information of the plurality of sensors to the server 3a, the clothes treating apparatus may transmit the state information about the load state to the server 3a.

Based on the internal state of the drum 30 being identified as an unloaded state, the clothes processing apparatus may control a plurality of processes to be maintained and control a next process, the water supply process.

In a case of controlling operation of the first water supply valve in the water supply process, the clothes treating apparatus may control the first water supply valve 41 to be opened when recognizing that the rotation speed of the driving motor 36 reaches the first target rotation speed, identify whether the water level in the tub is a reference water level based on water level information received from the water level sensor 200, and control the first water supply valve 41 to be closed based on the water level in the tub being identified as the reference water level.

In a case of controlling operation of the second water supply valve in the water supply process, the clothes treating apparatus may control the second water supply valve 42 to be opened while the driving motor 36 is maintained at the first target rotation speed, identify whether the water level in the tub is the reference water level based on water level information received from the water level sensor 200, and control the first water supply valve 41 to be closed based on the water level in the tub being identified as the reference water level.

The water supply valve controlled in the water supply process may be a valve set in a manufacturing stage or a valve selected by the user.

Based on a first time for which the rotation speed of the driving motor 36 is maintained at the first target rotation speed reaches the first reference time, the clothes treating apparatus may control the driving motor 36 to be accelerated for the second time.

In controlling the driving motor 36 to be accelerated, the clothes treating apparatus may recognize whether the rotation speed of the driving motor 36 reaches the second target rotation speed based on the rotation speed information detected by the first speed sensor 230.

Based on the rotation speed of the driving motor 36 reaching the second target rotation speed, the clothes treating apparatus may control the rotation speed of the driving motor 36 to be maintained at the second target rotation speed, and control the drain process.

The clothes treating apparatus may control the drain valve 74 to be opened and the drain pump 71 to be turned on.

Based on the second time for which the rotation speed of the driving motor 36 is maintained at the second target rotation speed reaching the second reference time, the clothes treating apparatus controls the rotation speed of the driving motor 36 to speed down, and controls the drain valve 74 to be closed and the drain pump 71 to be turned off.

The clothes treating apparatus may control the driving motor 36 to speed down for the third reference time from when the driving motor starts to speed down. Specifically, the clothes treating apparatus may control the driving motor 36 to be stopped after a lapse of the third reference time from when the driving motor 36 starts to speed down.

It is also possible that the clothes treating apparatus controls the circulation pump 76 to be turned on for a certain time based on completion of the water supply process, controls the circulation pump 76 to be turned off after a lapse of the certain time from when the circulation pump starts to be turned on, and controls the dehydrating process.

The clothes treating apparatus may perform the drying process based on the completion of the dehydrating process and the draining process.

The clothes treating apparatus may control the driving motor 36 to be accelerated while performing the drying process, recognize the rotation speed of the driving motor 36 based on the rotation speed information received from the first speed sensor 230 during acceleration control over the driving motor, and control the rotation speed of the driving motor 36 to be maintained at the third target rotation speed based on the rotation speed of the driving motor 36 being the third target rotation speed.

The clothes treating apparatus may control the first motor of the blower fan 87a to be accelerated while performing the drying process, recognize whether the rotation speed of the first motor is the first maximum rotation speed based on rotation speed information of the first motor received from the third speed sensor 250, and control the first motor to maintain the rotation speed of the first motor at the first maximum rotation speed based on the rotation speed of the first motor being the first maximum rotation speed.

The clothes treating apparatus may count a third time from when the driving motor 36 and the blower fan 87a start to be accelerated, control the second motor of the cooling fan 91a when the counted third time reaches a fourth reference period, recognize whether the rotation speed of the second motor is the second maximum rotation speed based on rotation speed information of the second motor of the cooling fan 91a received from the fourth speed sensor 260 during acceleration control over the second motor of the cooling fan 91a, and control the second motor to maintain the rotation speed of the second motor at the second maximum rotation speed based on the rotation speed of the second motor being the second maximum rotation speed.

The clothes treating apparatus may count a fourth time from when acceleration control over the second motor of the cooling fan 91a is started, and control the operation of the compressor 91 in response to the counted fourth time reaching a fifth reference time.

The clothes treating apparatus may control the motor for compressor arranged in the compressor 91 to be accelerated in controlling operation of the compressor 91, recognize whether the rotation speed of the motor for compressor is the fourth target rotation speed based on the rotation speed information detected by the second speed sensor 240 during acceleration control over the motor for compressor, and control the motor for compressor to be decelerated based on the rotation speed of the motor for compressor being the fourth target rotation speed.

The fourth target rotation speed may be a maximum rotation speed of the motor for compressor, which may be about 60 rps.

It is also possible for the clothes treating apparatus to control the driving motor 36, the first motor of the blower fan 87a and the second motor of the cooling fan 91a to be decelerated and stopped based on the deceleration control over the motor for compressor.

The clothes treating apparatus may collect detection information detected by the plurality of sensors while performing a washing process, a water supply process, a circulation process, a dehydrating process, a draining process and a drying process.

The detection information detected by the plurality of sensors may include at least one of sound information detected by the microphone 210 and vibration information detected by the vibration sensor 220. Specifically, the clothes treating apparatus may collect at least one of the sound information detected by the microphone 210 and the vibration information detected by the vibration sensor in operation 334 while performing the washing process, the water supply process, the circulation process, the dehydrating process, the draining process and the drying process.

The clothes treating apparatus may transmit the control information for the plurality of loads and detection information of the plurality of sensors corresponding to the first diagnosis mode to the server 3a, in operation 335.

Furthermore, when the internal state of the drum is identified as a loaded state while the first diagnosis mode is being performed, it is also possible for the clothes treating apparatus to delete the sound information and the vibration information collected in the first acceleration section of the driving motor before the loaded state is identified and a section in which the rotation speed of the driving motor is maintained at the first rotation speed.

Based on recognizing that the second diagnosis mode is performed while the laundry is accommodated in the drum, the clothes treating apparatus may transmit state information regarding a laundry accommodation state to the server 3a.

The clothes treating apparatus may recognize current information detected by a first current sensor based on recognizing that the laundry is accommodated in the drum, recognize the weight of the laundry based on the recognized current information, and transmit the weight information about the recognized weight of the laundry to the server 3a along with the state information regarding the laundry accommodation state.

On receiving diagnosis result information about the first diagnosis mode from the server 3a, the clothes treating apparatus may output the received diagnosis result information about the first diagnosis mode through the output module 102, in operation 336.

The outputting of the diagnosis result information through the output module 102 may include outputting the diagnosis result information through at least one of the display and the speaker.

The clothes treating apparatus may control transmission of service request information for the home appliance based on the diagnosis result information, or recognize failure response information corresponding to the diagnosis result information based on information stored in the first memory and output the recognized failure response information through the output module 102.

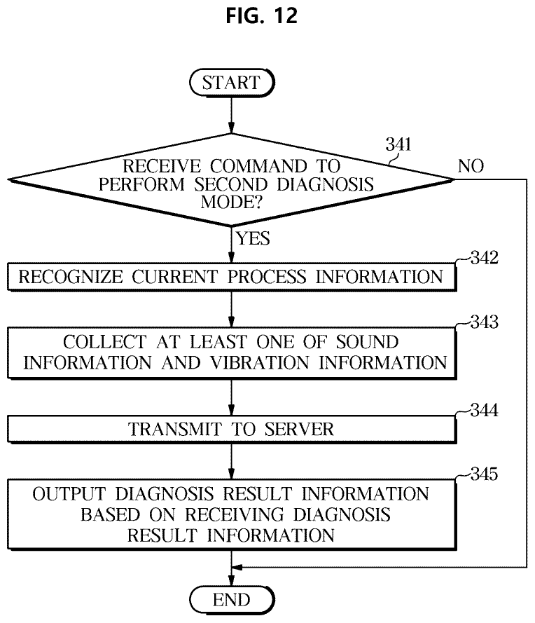

FIG. 12 is a control flowchart of a second diagnosis mode of a clothes treating apparatus according to an embodiment of the disclosure.

Referring to FIG. 12, the clothes treating apparatus may also control the second diagnosis mode to be performed based on a command to perform the second diagnosis mode being received in operation 341.

It is also possible that the clothes treating apparatus controls the second diagnosis mode to be performed when receiving a command to perform the second diagnosis mode from the user device 2a.

The clothes treating apparatus may recognize current process information while performing the second diagnosis mode, in operation 342.

The clothes treating apparatus may recognize whether the clothes treating apparatus is equipped with at least one of a microphone or a vibration sensor.

The clothes treating apparatus may collect information about a sound generated from the clothes treating apparatus for a reference diagnosis time based on recognizing that the clothes treating apparatus is equipped with the microphone, and collect information about vibration generated from the clothes treating apparatus based on recognizing that the clothes treating apparatus is equipped with the vibration sensor. In other words, the clothes treating apparatus may collect at least one of sound information and vibration information generated from the clothes treating apparatus while performing the second diagnosis mode, in operation 343.

Based on recognizing that the clothes treating apparatus is not equipped with the microphone and the vibration sensor, the clothes treating apparatus may output information requesting to collect at least one of the sound information and the vibration information through the output module 102.

The information requesting for collection may include indication information indicating through the user device 2a that at least one of the sound information and the vibration information is to be collected.

The information requesting for collection may include indication information about a method of collecting at least one of the sound information and the vibration information through the user device 2a.

The clothes treating apparatus may receive at least one of the sound information and the vibration information from the user device 2a after a lapse of the reference diagnosis time of the second diagnosis mode when the clothes treating apparatus is not equipped with the microphone and the vibration sensor.

The clothes treating apparatus may match and transmit the recognized current process information, the sound information received by the microphone 210 and the vibration information received by the vibration sensor 220 to the server 3a, in operation 344.

It is also possible that the clothes treating apparatus transmits, to the server 3a, weight information of the laundry and water level information along with the recognized current process information, the sound information received by the microphone 210 and the vibration information received by the vibration sensor 220 while performing the second diagnosis mode.

It is also possible that the clothes treating apparatus transmits, to the server 3a, the detection information detected by the at least one sensor along with the recognized current process information, the sound information received by the microphone 210 and the vibration information received by the vibration sensor 220 while performing the second diagnosis mode.

For example, based on the recognized current process information being the water supply process, the clothes treating apparatus may recognize water level information detected by the water level sensor 200, match and store the recognized water level information, the sound information received by the microphone 210 and the vibration information received by the vibration sensor 220, and transmit the current process information, the water level information, the sound information and the vibration information to the server 3a.

In another example, based on the recognized current process information being the dehydrating process, the clothes treating apparatus may match and store the rotation speed information detected by the first speed sensor 230, the sound information received by the microphone 210 and the vibration information received by the vibration sensor 220, and transmit the current process information, the rotation speed information of the driving motor, the sound information and the vibration information to the server 3a.

It is also possible that the clothes treating apparatus transmits, to the server 3a, the sound information and the vibration information received from the user device 2a along with the current process information.

Based on receiving diagnosis result information about the second diagnosis mode from the server 3a, the clothes treating apparatus may output the received diagnosis result information about the second diagnosis mode through the output module 102, in operation 345.

The outputting of the diagnosis result information through the output module 102 may include outputting the diagnosis result information through at least one of the display and the speaker.

The clothes treating apparatus may control transmission of service request information for the home appliance based on the diagnosis result information, or recognize failure response information corresponding to the diagnosis result information based on information stored in the first memory and output the recognized failure response information through the output module 102.

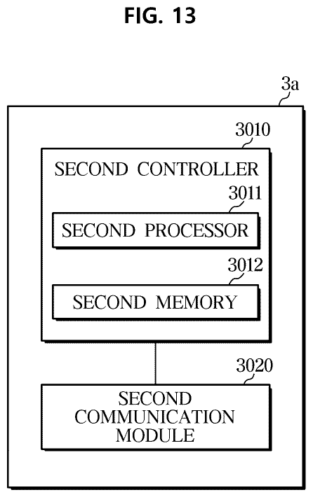

FIG. 13 is a control block diagram of a server that communicates with a clothes treating apparatus according to an embodiment of the disclosure.

Referring to FIG. 13, to differentiate components having the same names between the clothes treating apparatus and the server, the components of the server are named with the prefix ‘second-’.

The server 3a may include a second controller 3010 and second communication module 3020.

The second controller 3010 may be electrically connected to various parts and/or devices of the server 3a to control the various parts and/or devices. In other words, the second controller 3010 controls general operation of the server 3a.

The second controller 3010 may use at least one of an abnormal sound detection algorithm, a noise diagnosis and analysis algorithm, a vibration monitoring and analysis algorithm and a predictive maintenance algorithm to diagnose a failure of the home appliance.

The second controller 3010 may diagnose a failure of each type of home appliance based on reference diagnosis information for each type of home appliance, and diagnose a failure of each model of home appliances based on reference diagnosis information for each model of home appliance.

The second controller 3010 may train the diagnosis control information based on the reference diagnosis information for each type of home appliance, diagnosis control information, control information for a plurality of loads received from the home appliance and detection information of the plurality of sensors.

The second controller 3010 may train the diagnosis control information based on the reference diagnosis information for each model of home appliances, diagnosis control information, control information of a plurality of loads received from the home appliance and detection information of the plurality of sensors.

The reference diagnosis information may include reference information to differentiate normality from failure of each load of the home appliance.

The diagnosis control information may include a diagnosis algorithm to diagnose a failure of the home appliance. The diagnosis control information may include control information for the plurality of loads arranged in the home appliance.

The second controller 3010 may update diagnosis control information based on learned information and transmit the updated diagnosis control information to the home appliance.

On receiving performance information of the first diagnosis mode, control information for the plurality of loads and detection information of the plurality of sensors from a home appliance, the second controller 3010 may diagnose a failure of the home appliance based on the first diagnosis mode. In other words, the second controller 3010 may diagnose a failure of a home appliance related to a plurality of loads.

The detection information of the plurality of sensors may include at least one of the sound information and the vibration information.

On receiving performance information of the second diagnosis mode, process information, control information for at least one load and detection information of at least one sensor from a home appliance, the second controller 3010 may diagnose a failure of the home appliance based on the second diagnosis mode. In other words, the second controller 3010 may diagnose a failure of a home appliance related to a plurality of loads and the process information.

The detection information of the at least one sensor may include at least one of the sound information and the vibration information.

A configuration of the second controller that diagnoses a failure of a home appliance in relation with the first diagnosis mode will now be described.

The second controller 3010 may analyze sound information and vibration information.

The sound information may include information about one or more of the volume of the sound, the period of the sound and the frequency of the sound.

The vibration information may include information about the magnitude of the vibration, the period of the vibration and the frequency of the vibration.

When the home appliance is a clothing treating apparatus, the second controller 3010 may analyze control information for the plurality of loads, rotation speed information detected by the plurality of speed sensors and water level information.

When the home appliance is a clothing treating apparatus, the second controller 3010 may diagnose a failure of each load based on the analyzed sound information, vibration information, control information for the plurality of loads, detected rotation speed information detected by the plurality of speed sensors, water level information and reference diagnosis information. This will be described below.

The second controller 3010 may diagnose a failure of the driving motor or recognize e.g., a coupling error of the driving motor, based on the reference diagnosis information for the driving motor corresponding to the washing process, the rotation speed information of the driving motor detected in the washing process, the vibration information and the sound information, in diagnosing a failure of the clothes treating apparatus based on the first diagnosis mode.

The reference diagnosis information of the driving motor corresponding to the washing process may include reference rotation speed information, reference vibration information and reference sound information of the driving motor when the driving motor is in the normal state in the washing process.

It is also possible for the second controller 3010 to diagnose a failure of the water supply valve based on reference diagnosis information corresponding to the water supply process, water level information detected in the water supply process, vibration information and sound information.

The reference diagnosis information corresponding to the water supply process may include reference water level information, reference vibration information and reference sound information over time when the water supply valve is in the normal state.

The second controller 3010 may diagnose a failure of the driving motor or recognize e.g., a coupling error of the driving motor based on the reference diagnosis information for the driving motor corresponding to the dehydrating process, the rotation speed information of the driving motor detected in the dehydrating process, the vibration information and the sound information.

The reference diagnosis information of the driving motor corresponding to the dehydrating process may include reference rotation speed information, reference vibration information and reference sound information of the driving motor when the driving motor is in the normal state in the dehydrating process.

It is also possible for the second controller 3010 to diagnose a failure of the drain pump and the drain valve based on reference diagnosis information regarding the draining process, water level information, vibration information and sound information detected in the draining process.

The reference diagnosis information regarding the draining process may include reference water level information, reference vibration information and reference sound information over time when the drain pump and the drain valve are in the normal state.

It is also possible for the second controller 3010 to diagnose a failure of the circulation pump based on reference diagnosis information regarding the circulation process, water level information, vibration information and sound information detected in the circulation process.

The reference diagnosis information regarding the circulation process may include reference water level information, reference vibration information and reference sound information over time when the circulation pump is in the normal state.

It is also possible that the second controller 3010 diagnoses a failure of the drying device based on reference diagnosis information regarding the drying process, rotation speed information of the driving motor detected in the drying process, rotation speed information of the blower fan, the rotation speed information of the compressor, rotation speed information of the cooling fan, vibration information and sound information.

The reference diagnosis information regarding the drying process may include reference rotation speed information of the driving motor, reference rotation speed information of the blower fan, reference rotation speed information of the compressor, reference rotation speed information of the cooling fan, reference vibration information and reference sound information over time when the drying device is in the normal state.

It is also possible for the second controller 3010 to recognize whether state information corresponding to an accommodation state of the laundry and weight information of the laundry are received from the clothes treating apparatus and recognize reference diagnosis information for each process based on the state information corresponding to the accommodation state of the laundry and the weight information of the laundry being received, when diagnosing a failure of the clothes treating apparatus based on performance information of the first diagnosis mode.

It is also possible that the second controller 3010 recognizes each reference diagnosis information for each process corresponding to the weight information of the laundry and diagnoses a failure for each process based on the recognized reference diagnosis information for each process, the control information for the plurality of loads and the detection information of the plurality of sensors.

The second controller 3010 may recognize whether there is a fastening error and an installation error based on the analyzed sound information, the control information for the plurality of loads, the detected rotation speed information detected by the plurality of speed sensors, the water level information and the reference diagnosis information. This will be described by taking an example.

When the magnitude of vibration is larger than a reference vibration magnitude and the volume of the sound is higher than a reference sound volume, the cycle of the sound is faster than the reference cycle, and the frequency of the sound is in the bass range, the second controller 3010 may recognize it as an installation error from poor grounding of the housing 10.

In another example, when the volume of the sound is lower than the reference sound volume, the cycle of the sound is smaller than a cycle corresponding to rotation speed of the drum, and the cycle of the sound is faster than the reference cycle, the second controller 3010 may recognize it as a vibration fault of the housing or tub.

In another example, when the cycle of the sound corresponds to a cycle corresponding to the rotation speed of the drum or the cycle of the sound is shorter than the reference cycle, and the frequency of the sound is in the high-pitched range, the second controller 3010 may recognize it as a fastening error of the tub.

The second controller 3010 may transmit the diagnosis result information corresponding to the first diagnosis mode to the clothes treating apparatus 1001.

The second controller 3010 may transmit the diagnosis result information corresponding to the first diagnosis mode to the user device 2a.

Examples of failure diagnosis of the plurality of loads through the second controller 3010 are not limited thereto.

A configuration of the second controller that diagnoses a failure of the clothes treating apparatus in relation with the second diagnosis mode will now be described.

On receiving performance information of the second diagnosis mode, control information for at least one load, detection information of at least one sensor and process information from the clothes treating apparatus, the second controller 3010 may recognize reference diagnosis information corresponding to the process information and diagnose a failure corresponding to the process information based on the recognized reference diagnosis information, control information for the at least one load and detection information of the at least one sensor.

The process information is for failure diagnosis, and may have been performed by the clothes treating apparatus at a time to detect the sound and vibration.

The reference diagnosis information corresponding to the process information may include reference diagnosis information corresponding to the washing process, reference diagnosis information corresponding to the water supply process, reference diagnosis information corresponding to the dehydrating process, reference diagnosis information corresponding to the circulation process, reference diagnosis information corresponding to the draining process and reference diagnosis information corresponding to the drying process.

The second controller 3010 may diagnose a failure corresponding to the process information based on reference diagnosis information, control information for the at least one load, vibration information and sound information regarding the process information.

The failure corresponding to the process information may include a failure related to the at least one load.

The failure diagnosis corresponding to the process information is equal to the failure diagnosis corresponding to each process information included in the first diagnosis mode, so the description will not be repeated.

The second controller 3010 may diagnose a failure corresponding to the process information based on reference diagnosis information, control information for the at least one load, rotation speed information detected by the at least one speed sensor, water level information, vibration information and sound information regarding the process information.

In receiving the performance information of the second diagnosis mode from the clothes treating apparatus, the second controller 3010 may further receive weight information of the laundry. The second controller 3010 may recognize reference diagnosis information corresponding to the weight information of the laundry and the process information.

The second controller 3010 may transmit the diagnosis result information of the second diagnosis mode to the clothes treating apparatus.

The second controller 3010 may transmit the diagnosis result information of the second diagnosis mode to the user device 2a.

Computation speed and storage capacity of the second controller 3010 may be higher and larger than the computation speed and storage capacity of the first controller 300 of the clothes treating apparatus 1001.

The second controller 3010 may include at least one second processor 3011 for controlling operation of the server 3a, and at least one second memory 3012 for storing a program and data for controlling the operation of the server 3a.

The at least one second processor 3011 may include at least one memory for storing data in the form of a program and an algorithm for controlling operations of components in the server 3a, and one or more processor chips or one or more processing cores for performing the aforementioned operations by using the data stored in the at least one memory.

The at least one second processor 3011 may process various data and various signals based on instructions, data, a program and/or software stored in the second memory 3012.

The at least one second processor 3011 may include one or more of a central processing unit (CPU), a graphics processing unit (GPU), an accelerated processing unit (APU), a many-integrated-core (MIC), a digital signal processor (DSP), a neural processing unit (NPU), a hardware accelerator or a machine learning accelerator.

The second memory 3012 stores diagnosis control information for each home appliance and each model. It is also possible for the second memory 3012 to update the diagnosis control information for each home appliance and each model.

The second memory 3012 may store the failure response information corresponding to the diagnosis result information for each home appliance and each model.

The second memory 3012 may store data required for various embodiments.

The second memory 3012 may be implemented in the form of memory embedded in or detachable from the server 3a depending on the data storage use. For example, data for operating the server 3a may be stored in the memory embedded in the server 3a and data for an extended function of the server 3a may be stored in the memory detachable from the server 3a.

In the meantime, the memory embedded in the server 3a may be implemented with at least one of a volatile memory (e.g., dynamic random access memory (DRAM), static RAM (SRAM), or synchronous dynamic RAM (SDRAM), or the like) or non-volatile memory (e.g., a one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive or solid state drive (SSD)).

The memory detachable from the server 3a may be implemented in such a format as memory card (e.g., compact flash (CF), secure digital (SD), micro-SD, mini-SD, extreme digital (xD), multi-media card (MMC), or the like) or external memory (e.g., USB memory) connectable to a USB port, without being limited thereto.

The second memory 3012 may include one, two or more memory chips or one, two or more memory blocks.

AI-related functions according to the disclosure may operate with the one or more second processors 3011 and second memories 3012.

The one or more second processors 3011 may include a universal processor, such as a central processing unit (CPU), an application processor (AP), a digital signal processor (DSP), or the like, a graphic processing unit (GPU), a vision processing unit (VPU), or the like, or a dedicated artificial intelligence (AI) processor, such as a neural processing unit (NPU).

The one or more second processors 3011 may control processing of input data according to a predefined operation rule or an AI model stored in the second memory 3012. When the one or more processors are the dedicated AI processors, they may be designed in a hardware structure that is specific to dealing with a particular AI model.

The predefined operation rule or the AI model may be made by learning. Specifically, the AI model being made by learning refers to the predefined operation rule or the AI model established to perform a desired feature (or an object) being made when a basic AI model is trained by a learning algorithm with a lot of training data. Such learning may be performed by a device itself in which AI is performed according to the disclosure, or by a separate server and/or system. Examples of the learning algorithm may include supervised learning, unsupervised learning, semi-supervised learning, or reinforcement learning, without being limited thereto.

The AI model may include a plurality of neural network layers. Each of the plurality of neural network layers may have a plurality of weight values, and perform neural network operation through operation between an operation result of the previous layer and the plurality of weight values. The plurality of weight values owned by the plurality of neural network layers may be optimized by learning results of the AI model. For example, the plurality of weight values may be updated to reduce or minimize a loss value or a cost value obtained by the AI model during a training procedure. An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, without being limited thereto.

It is also possible that the server 3a further includes an input module for receiving user inputs and an output module for outputting information relating to an operation of the server 30a.

The second communication module 3020 may perform communication with the clothes treating apparatus 1001. The second communication module 3020 may communicate with the user device 2a.

A specific configuration of the second communication module 3020 may be equal to the specific configuration of the first communication module. Accordingly, the detailed description of the second communication module 3020 will not be repeated.

At least one component may be added to or omitted from the server 3a to correspond to the performance of the server 3a as shown in FIG. 13. Furthermore, it will be obvious to those of ordinary skill in the art that the relative positions of the components may be changed to correspond to the performance or structure of the server 3a.

The components shown in FIG. 13 may refer to software, or hardware components, such as field programmable gate arrays (FPGAs) and application specific integrated circuits (ASICs).

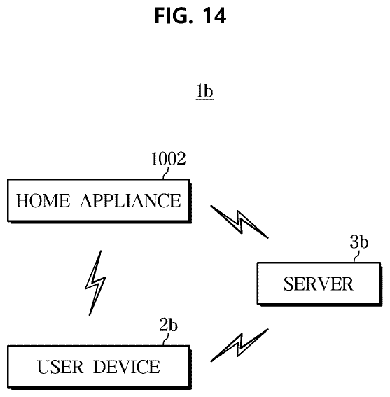

FIG. 14 is a block diagram of a home network system including a home appliance according to an embodiment of the disclosure.

Referring to FIG. 14, a home network system 1b may include a home appliance 1002 and a server 3a, and further include a user device 2b.

On receiving a command to perform a first diagnosis mode as a user input, the home appliance 1002 may control operations of a plurality of loads based on diagnosis control information.

The diagnosis control information may include control information for each of the plurality of loads.

When the load is a motor, the control information may include at least one of acceleration control, deceleration control, speed maintenance control, stop control, target rotation speed, maximum rotation speed, acceleration, or reference time for maintaining a rotation speed.

The home appliance 1002 may collect detection information detected from a plurality of sensors while performing the first diagnosis mode, and match and store the collected detection information of each of the plurality of sensors with control information for each of the plurality of loads.

The home appliance 1002 may store the detection information of each of the plurality of sensors as being matched with control information for each of the plurality of loads to correspond to a performance time of the first diagnosis mode.

The plurality of sensors may include a sensor for detecting information about an operation of at least one load, and a sensor for detecting information about an operation environment of the home appliance.

When the load is a motor, the information about an operation of the load may include rotation speed information of the motor and current information about a current flowing to the motor.

The operation environment of the home appliance may include outside temperature, outside humidity, inside temperature, inside humidity, a water level of the home appliance, water temperature of the home appliance, whether the door is open or closed, or the like.

It is also possible that the home appliance 1002 controls the first diagnosis mode to be performed based on a preset cycle.

The home appliance 1002 may transmit the stored detection information of each of the plurality of sensors and control information for each of the plurality of loads to the user device 2b while performing the first diagnosis mode.

The home appliance 1002 may receive diagnosis control information from the user device 2b or the server 3b and store the received diagnosis control information. The diagnosis control information received from the user device 2b or the server 3b may include diagnosis control information collected, trained, and then updated in the server 3b.

The diagnosis control information may include a diagnosis algorithm to diagnose a failure of the home appliance.

The home appliance 1002 may identify whether a command to perform a second diagnosis mode is received as a user input while controlling operation of at least one load, recognize control information for the at least one load based on the command to perform the second diagnosis mode being identified as received, collect detection information detected by at least one sensor, and match and store the detection information detected by the at least one sensor and the control information for the at least one load.

The home appliance 1002 may match and transmit the detection information detected by the at least one sensor and the control information for the at least one load to the user device 2b.

It is also possible that the home appliance 1000 performs the second diagnosis mode for a reference diagnosis time. In this case, the home appliance 1000 may collect the detection information detected by the at least one sensor for the reference diagnosis time for which the second diagnosis mode is performed, and recognize the control information for the at least one load for the reference diagnosis time.

When the home appliance is a clothes treating apparatus and the load is a driving motor, the control information for the driving motor may include at least one of an operation mode, acceleration control, deceleration control, speed maintenance control, stop control, target rotation speed, acceleration, or reference time for maintaining a rotation speed.

In the case that the home appliance is the clothes treating apparatus, the operation mode may include a laundry mode and a drying mode. The laundry mode may include at least one of a washing process, a rinsing process, an intermediate dehydrating process, a final dehydrating process, a draining process and a water supply process.

When the home appliance is an air conditioner, the operation mode may include at least one of a cooling mode, a heating mode and a dehumidifying mode.

The detection information of the at least one sensor may include sound information about a sound generated from the home appliance.

The detection information of the at least one sensor may include vibration information about a vibration generated from the home appliance.

The detection information of each of the plurality of sensors may include environment information about an operation environment of the home appliance. For example, the operation environment of the home appliance may include outside temperature, outside humidity, inside temperature, inside humidity, a water level of the home appliance, water temperature of the home appliance, whether the door is open or closed, or the like.

The home appliance 1002 may receive diagnosis result information from the user device 2b or the server 3b and output the received diagnosis result information.

The home appliance 1002 may display the diagnosis result information received from the user device 2b or the server 3b in an image or a voice.

It is also possible for the home appliance 1002 to communicate with the user device 2b and receive a command to perform the first diagnosis mode or a command to perform the second diagnosis command from the user device 2b.

The user device 2b may communicate with the home appliance 1002 and the server 3b.

When receiving a command to perform the first diagnosis mode as a user input, the user device 2b may transmit the received command to perform the first diagnosis mode to the home appliance 1002, and when receiving a command to perform the second diagnosis mode as a user input, the user device 2b may transmit the received command to perform the second diagnosis mode to the home appliance 1002.

The user device 2b may collect sound information through a microphone and collect vibration information through a vibration sensor while the first diagnosis mode is being performed.

The user device 2b may receive control information for a plurality of loads and detection information of the plurality of sensors from the home appliance based on completion of performing the first diagnosis mode, match the received control information for the plurality of loads and detection information of the plurality of sensors and transmit the matched information to the server 3b.

The user device 2b may collect sound information of the home appliance through the microphone and collect vibration information through the vibration sensor while the second diagnosis mode is being performed.

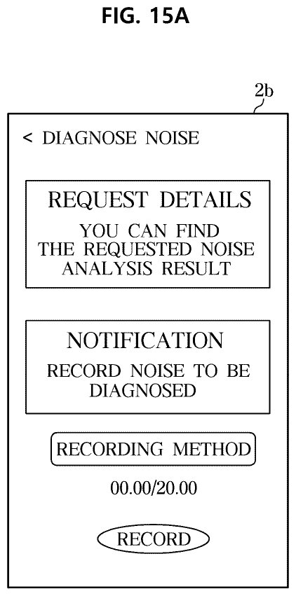

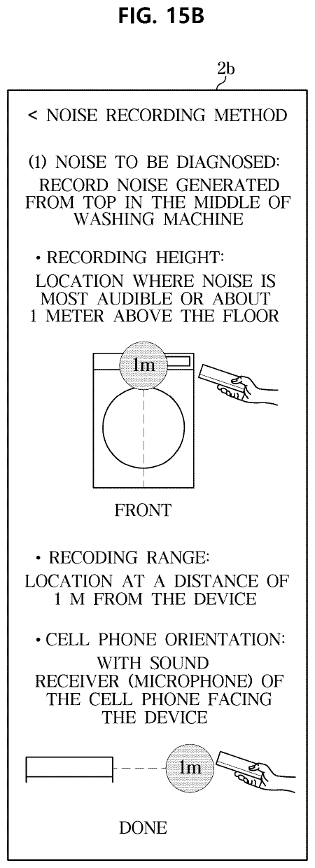

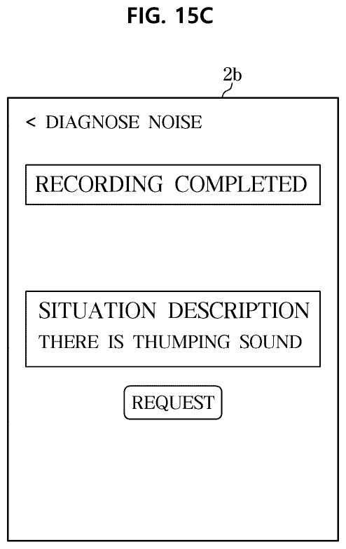

The user device 2b may include an application for diagnosing a failure of the home appliance. The user device 2b may output indication information relating to fault diagnosis of the home appliance based on a command to execute the application. This will be described in connection with FIGS. 15A, 15B, and 15C.

FIGS. 15A, 15B, and 15C illustrate displays on a user device that communicates with a home appliance according to various embodiments of the disclosure.

Referring to FIG. 15A, the user device 2b may output the indication information regarding the failure diagnosis of the home appliance based on the command to perform the second diagnosis mode being received.

Referring to FIG. 15B, the user device 2b may output indication information about a method of recording a sound generated from the home appliance 1002.

Referring to FIG. 15C, the user device 2b may output indication information about completion of recoding of the sound generated from the home appliance 1002 and a failure diagnosis request.

The user device 2b may receive process information and control information for at least one load from the home appliance based on completion of performing the second diagnosis mode, match the received control information for the at least one load and the process information with the sound information and transmit the matched information to the server 3b.

It is also possible for the user device 2b to match the received control information for the at least one load and the process information with the vibration information and transmit the matched information to the server 3b based on completion of performing the second diagnosis mode.

It is also possible for the user device 2b to match the received control information for the at least one load and the process information with the vibration information and the sound information and transmit the matched information to the server 3b based on completion of performing the second diagnosis mode.

The user device 2b may further receive detection information of at least one sensor from the home appliance based on completion of performing the second diagnosis mode, and transmit the received detection information of the at least one sensor to the server 3b.

The detection information of the at least one sensor may include detection information of a sensor for detecting an operation of at least one load.

On receiving the diagnosis result information from the server 3b, the user device 2b may output the received diagnosis result information. The user device 2b may transmit the received diagnosis result information to the home appliance 1002.

On receiving performance information of the first diagnosis mode, detection information of each of the plurality of sensors or control information for each of the plurality of loads from the user device 2b, the server 3b diagnoses a failure throughout the home appliance 1002 based on preset reference diagnosis information, the received detection information of each of the plurality of sensors or control information for each of the plurality of loads.

For example, the server 3b may diagnose abnormal noise from a fault of a load of the home appliance, a fastening error of a load, or an installation error of the home appliance based on information received from the user device 2b. The server 3b may identify a cause of the abnormal noise and a cause of the fault of the load, and recognize the identified information as the diagnosis result information.

On receiving performance information of the second diagnosis mode, detection information of the at least one sensor, and control information for at least one load from the user device 2b, the server 3b may diagnose a failure related to operation of the at least one load based on preset reference diagnosis information, the received detection information of the at least one sensor and control information for the at least one load.

The server 3b may communicate with the user device 2b, and is also able to transmit the diagnosis result information about the failure diagnosis for the home appliance 1002 to the user device 2b.

The server 3b may transmit the diagnosis result information about failure diagnosis for the home appliance 1002 to the home appliance 1002.

The server 3b may learn the diagnosis control information based on the control information for each of the plurality of loads, detection information of each of the plurality of sensors and diagnosis control information of the home appliance in relation with the first diagnosis mode, update the diagnosis control information based on the learned information, and transmit the updated diagnosis control information to the home appliance 1002.

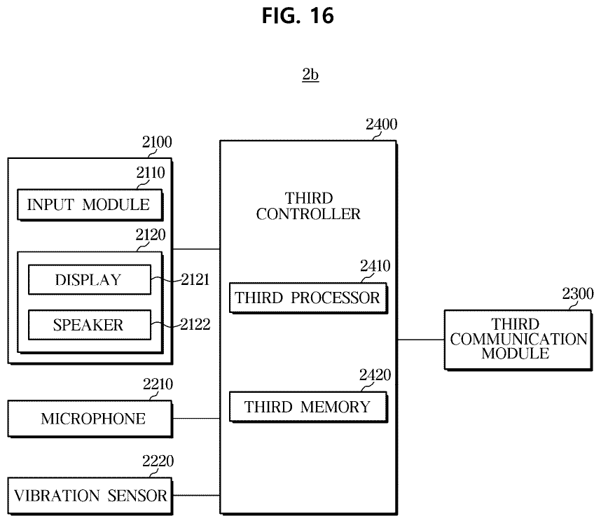

FIG. 16 is a control block diagram of a user device that communicates with a home appliance according to an embodiment of the disclosure.

Referring to FIG. 16, in the embodiment of the disclosure, the user device 2b in communication with the home appliance 1002 may include a user interface 2100, a microphone 2210, a vibration sensor 2220, a third communication module 2300 and a third controller 2400.

The user interface 2100 may receive a user input and output various information about the operation of the user device 2b.

The user interface 2100 may include an input module 2110 and an output module 2120.

The input module 2110 receives a user input.

The input module 2110 may receive commands to execute and stop an application for diagnosing a failure of the home appliance, and receive a command to select a type of home appliance and a command to select a model of home appliance.

The input module 2110 may receive a command to perform the first diagnosis mode and a command to perform the second diagnosis mode.

The input module 2110 may also receive a command to turn on or off the microphone and a command to turn on or off the vibration sensor.

The input module 2110 may include hardware devices, such as a switch, a pedal, a keyboard, a mouse, a track ball, various levers, a handle, a stick, or the like in addition to buttons and a jog dial.

The input module 2110 may include a graphical user interface (GUI), such as a touch pad, i.e., a software device. The touch pad may be implemented with a touch screen panel (TSP), thus forming an interlayer structure with the output module 2120.

The output module 2120 outputs operation information of the user device 2b.

The output module 2120 may output a screen of the application for failure diagnosis for the home appliance, and output information relating to the failure diagnosis for the home appliance.

The output module 2120 may output indication information corresponding to the first diagnosis mode, and output indication information corresponding to the second diagnosis mode.

The output module 2120 may output diagnosis result information corresponding to the first diagnosis mode.

The output module 2120 may also output indication information about a performance cycle of the first diagnosis mode and indication information about a suggestion to perform the first diagnosis mode.

The output module 2120 may output diagnosis result information corresponding to the second diagnosis mode.

The output module 2120 may also output a state of communication with the home appliance 1002 and output a state of communication with the server 3b.

The output module 2120 may include a display 2121 and a speaker 2122.

The display 2121 may display output information in an image.

The display 2121 includes a plurality of 7-segments.

The display 2121 may be provided as a liquid crystal display (LCD), a digital light processing (DLP) panel, a plasma display panel (PDP), an electro luminescence (EL) panel, an electrophoretic display (EPD) panel, an electrochromic display (ECD) panel, a light emitting diode (LED) panel, an organic light emitting diode (OLED) panel, or the like, but is not limited thereto.

The speaker 2122 may output the output information in an indication sound.

The indication sound may include a notification sound, such as a beep sound, or a voice.

The microphone 2210 is a sound-receiving sensor, which detects a sound generated from around the user device and transmits sound information about the detected sound to the third controller 2400.

The sound generated from around the user device may include a sound generated from a home appliance for failure diagnosis.

There may be one or more microphones 2210. The microphone 2210 may be provided in an array type.

The vibration sensor 2200 detects vibration generated from or from around the user device and transmits vibration information about the detected vibration to the third controller 2400.

The vibration generated from around the user device may include vibration generated from another device the user device contacts and delivered to the user device.

The vibration sensor 2220 may be, but not exclusively, a capacitive type MEMS acceleration sensor, a piezoresistive type MEMS acceleration sensor, a resistive type vibration sensor, a capacitive type vibration sensor, an optical vibration sensor, a piezoelectric sensor, an ultrasonic sensor, or a gyro sensor.

The third communication module 2300 may include various communication circuits for performing wired communication and/or wireless communication with an external device (e.g., a server and/or another home appliance).

A configuration for communication of the third communication module 2300 may be equal to the configuration for communication of the first communication module 150. Hence, the detailed description of the configuration for communication of the third communication module 2300 will not be repeated.

The third controller 2400 may be electrically connected to various parts and/or devices of the user device 2b to control the various parts and/or devices. In other words, the third controller 2400 controls general operation of the user device 2b.

The third controller 2400 may control an operation of the user device 2b based on a user input received by the input module 2110.

The third controller 2400 may control the output module 2120 to output operation information relating to the operation of the user device 2b.

The third controller 2400 may receive a command to execute an application for failure diagnosis for a home appliance through the input module 2110, control the application to be executed based on the receiving of the command to execute the application, and control the output module to output execution information of the application.

The third controller 2400 may receive a device name and a model name of the home appliance from the input module 2110, store the received device name and model name of the home appliance, and transmit the received device name and model name of the home appliance to the server 3b in diagnosing a failure of the home appliance.

Based on receiving of a command to perform the first diagnosis mode from the input module 2110, the third controller 2400 may transmit the command to perform the first diagnosis mode to the home appliance 1002.

Based on receiving of a command to perform the second diagnosis mode from the input module 2110, the third controller 2400 may transmit the command to perform the second diagnosis mode to the home appliance 1002.

Based on receiving of a command to perform the first diagnosis mode or the second diagnosis mode, the third controller 2400 may control the output module to output indication information for diagnosing a failure of the home appliance.

The third controller 2400 may also control the output module to output indication information relating to a suggestion to perform the first diagnosis mode based on the cycle of the first diagnosis mode.

Based on receiving of the command to perform the first diagnosis mode or the second diagnosis mode, the third controller 2400 may control the microphone 2210 and the vibration sensor 2220 to be activated.

The third controller 2400 may collect, from the home appliance 1002, sound information through the microphone 2210 and vibration information through the vibration sensor 2220 while performing the first diagnosis mode. The third controller 2400 may collect sound information and vibration information corresponding to a performance time of the first diagnosis mode.

In response to receiving of control information for a plurality of loads and detection information of the plurality of sensors from the home appliance 1002 based on the performing of the first diagnosis mode, the third controller 2400 may match the received control information for the plurality of loads and detection information of the plurality of sensors with the collected sound information and vibration information and store the matched information.

The third controller 2400 may also receive the control information for the plurality of loads and detection information of the plurality of sensors from the home appliance periodically while performing the first diagnosis mode or when the performance of the first diagnosis mode is completed.

The control information for the plurality of loads and detection information of the plurality of sensors may include information about a performance time of the first diagnosis mode.

The third controller 2400 may match and store sound information, vibration information and control information for the loads and detection information of the sensors collected in time sequence of the performance time of the first diagnosis mode.

In a case that the home appliance is a clothes treating apparatus, the control information for the plurality of loads may include open control information for the first and second water supply valves 41 and 42, close control information for the first and second water supply valves 41 and 42, acceleration control information for the driving motor 36, deceleration control information for the driving motor 36, rotation speed maintenance control information for the driving motor 36, open control information for the drain valve 74, close control information for the drain valve 74, turn-on control information for the drain pump 71, turn-off control information for the drain pump 71, turn-on control information for the circulation pump 76 and turn-off control information for the circulation pump 76.

The control information for the plurality of loads may include acceleration control information for the driving motor 36, rotation speed maintenance control information for the driving motor 36, acceleration control information for the first motor of the blower fan 87a, rotation speed maintenance control information for the first motor of the blower fan 87a, acceleration control information for the second motor of the cooling fan 91a, rotation speed maintenance control information for the second motor of the cooling fan 91a, turn-on control information for the compressor 91 and turn-off control information for the compressor 91.

When the home appliance is a clothing treating apparatus, the detection information of the plurality of sensors may include rotation speed information detected by the plurality of speed sensors and water level information.

Based on completion of performing the first diagnosis mode, the third controller 2400 may transmit the control information for the plurality of loads and the detection information of the plurality of sensors to the server 3b and transmit at least one of the sound information and the vibration information to the server 3b.

The sound information detected through the microphone 2210 may include information about a sound generated from the driving motor that is being accelerated for the first time, information about a sound generated from the driving motor that is being maintained at the first target rotation speed, information about a sound generated from the driving motor that is being accelerated for the second time, information about a sound generated from the driving motor that is being maintained at the second target rotation speed and information about a sound generated from the driving motor being decelerated.

The sound information detected through the microphone 2210 may further include sound information relating to a water supply process while the water supply valve is being opened, sound information relating to a draining process while the drain valve is being opened and the drain pump is being turned on, and sound information relating to a circulation process while the circulation pump is being turned on.

The sound information detected through the microphone 210 may include information about a sound generated during acceleration of the driving motor 36 while in the drying process, information about a sound generated during maintenance of the rotation speed of the driving motor 36, information about a sound generated during acceleration of the blower fan 87a, information about a sound generated during maintenance of rotation speed of the blower fan 87a, information about a sound generated during acceleration of the cooling fan 91a, information about a sound generated during maintenance of rotation speed of the cooling fan 91a, information about a sound generated during turn-on operation of the compressor 91 and information about a sound generated during turn-off of the compressor 91.

The vibration information detected through the vibration sensor 2220 may include information about a vibration generated by rotation of the driving motor that is being accelerated for the first time, information about a vibration generated by rotation of the driving motor that is being maintained at the first target rotation speed, information about a vibration generated by rotation of the driving motor that is being accelerated for the second time, information about a vibration generated by rotation of the driving motor that is being maintained at the second target rotation speed and information about a vibration generated by rotation of the driving motor being decelerated.

The vibration information detected through the vibration sensor 2220 may further include vibration information relating to a water supply process while the water supply valve is being opened, vibration information relating to a draining process while the drain valve is being opened and the drain pump is being turned on, and vibration information relating to a circulation process while the circulation pump is being turned on.

The vibration information detected through the vibration sensor 220 may include information about vibration generated by acceleration of the driving motor 36 while in the drying process, information about vibration generated by maintenance of the rotation speed of the driving motor 36, information about vibration generated by acceleration of the blower fan 87a, information about vibration generated by maintenance of rotation speed of the blower fan 87a, information about vibration generated by acceleration of the cooling fan 91a, information about vibration generated by maintenance of rotation speed of the cooling fan 91a, information about vibration generated by turn-on operation of the compressor 91 and information about vibration generated by turn-off of the compressor 91.

In response to diagnosis result information of the first diagnosis mode being received from the server 3b after the performance information of the first diagnosis mode, the control information for the plurality of loads, the detection information of the plurality of sensors, the sound information and the vibration information are transmitted to the server 3b, the third controller 2400 may control the output module 2120 to output the received diagnosis result information of the first diagnosis mode.

The third controller 2400 may also transmit the diagnosis result information regarding the first diagnosis mode to the home appliance 1002.

How to control the home appliance based on a command to perform the first diagnosis mode is equal to how to control the home appliance in the above embodiment of the disclosure, so the description thereof will not be repeated.

Based on a command to perform the second diagnosis mode being received, the third controller 2400 may recognize information about a current process being performed in the home appliance, collect sound information received by the microphone 2210, and collect vibration information received by the vibration sensor 2220. The third controller 2400 may collect sound information and vibration information for a preset reference diagnosis time.

The third controller 2400 may receive control information for at least one load arranged in the home appliance from the home appliance while performing the second diagnosis mode, and further receive detection information of at least one sensor.

In a case that the home appliance is a clothes treating apparatus, the third controller 2400 may further receive weight information of the laundry and water level information from the home appliance, and transmit the weight information of the laundry and the water level information to the server 3b.

The third controller 2400 may match and store the control information for at least one load, the detection information of at least one sensor, the sound information received by the microphone 2210 and the vibration information received by the vibration sensor 2220.

For example, based on the recognized process information being the water supply process, the third controller 2400 may match and store the water level information detected by the water level sensor 200, the sound information received by the microphone 2210 and the vibration information received by the vibration sensor 2220, and transmit the recognized process information, the water level information, the sound information and the vibration information to the server 3b.

In another example, based on the recognized current process information being the dehydrating process, the third controller 2400 may match and store the rotation speed information detected by the first speed sensor 230, the sound information received by the microphone 2210 and the vibration information received by the vibration sensor 2220, and transmit the current process information, the rotation speed information of the driving motor, the sound information and the vibration information to the server 3b.

The third controller 2400 may match and store the control information for at least one load, the detection information of at least one sensor, the sound information received by the microphone 2210 and the vibration information received by the vibration sensor 2220 in time sequence based on a performance time of the second diagnosis mode.

The third controller 2400 may transmit the recognized current process information, the weight information of the laundry, the water level information and the matched information to the server 3b.

On receiving diagnosis result information about the second diagnosis mode from the server 3b, the third controller 2400 may control the output module 2120 to output the received diagnosis result information regarding the second diagnosis mode.

The third controller 2400 may also transmit the diagnosis result information regarding the second diagnosis mode to the home appliance 1002.

How to control the home appliance based on a command to perform the second diagnosis mode is equal to how to control the home appliance in the above embodiment of the disclosure, so the description thereof will not be repeated.

A control configuration of the server 3b for diagnosing a failure of a home appliance is also equal to the control configuration of the server 3b in the aforementioned embodiment of the disclosure, so the description thereof will not be repeated.

The third controller 2400 may include at least one third processor 2410 for controlling operation of the user device 2b, and at least one third memory 2420 for storing a program and data for controlling the operation of the user device 2b.

At least one component may be added to or omitted from the user device 2b to correspond to the performance of the user device 2b as shown in FIG. 16. Furthermore, it will be obvious to those of ordinary skill in the art that the relative positions of the components may be changed to correspond to the performance or structure of the user device 2b.

The components of the personal mobility device shown in FIG. 16 may refer to software, or hardware components, such as FPGAs and ASICs.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be ROM, RAM, magnetic tape, magnetic disk, flash memory, optical data storage device, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in forms and details may be made therein without departing from the spirit and scope of the of the disclosure as defined by the appended claims and their equivalents.

What is claimed is:

1. A home appliance comprising:
an input module configured to receive a user input;
an output module;
a communication module configured to perform communication with a server;
a plurality of loads;
at least one sensor;
memory, comprising one or more storage media, storing instructions; and
at least one processor communicatively coupled to the input module, the output module, the communication module, the plurality of loads, the at least one sensor and the memory,
wherein the instructions, when executed by the at least one processor individually or collectively, cause the home appliance to:
control operations of the plurality of loads based on diagnosis control information in response to a command to perform a first diagnosis mode being selected through the input module,
control the communication module to transmit, to the server,
control information for the plurality of loads and detection information detected by the at least one sensor while performing the first diagnosis mode,
control the output module to output diagnosis result information received from the server,
control the communication module to transmit, to the server, and
control information for at least one of the plurality of loads and detection information detected by the at least one sensor in response to a command to perform a second diagnosis mode being received through the input module during operation of at least one load of the plurality of loads.

2. The home appliance of claim 1,
wherein the at least one sensor comprises at least one of a microphone for detecting sound and a vibration sensor for detecting vibration, and
wherein the instructions, when executed by the at least one processor individually or collectively, further cause the home appliance to store at least one of sound information detected by the microphone and vibration information detected by the vibration sensor based on a performance time of the first diagnosis mode as being matched with the control information for the plurality of loads and the detection information detected by the at least one sensor.

3. The home appliance of claim 1,
wherein the at least one sensor comprises at least one of a microphone for detecting sound and a vibration sensor for detecting vibration, and
wherein the instructions, when executed by the at least one processor individually or collectively, further cause the home appliance to:
control the second diagnosis mode to be performed for a reference diagnosis time, and
store at least one of sound information detected by the microphone and vibration information detected by the vibration sensor based on a performance time of the second diagnosis mode as being matched with the control information for the plurality of loads and the detection information detected by the at least one sensor.

4. The home appliance of claim 1,
wherein the communication module is configured to communicate with a user device and receive sound information collected by the user device, and
wherein the instructions, when executed by the at least one processor individually or collectively, further cause the home appliance to:
control the communication module to transmit, to the server, the sound information received during the first diagnosis mode as being matched with the control information for the plurality of loads and the detection information of the at least one sensor, and
control the communication module to transmit, to the server, the sound information received during the second diagnosis mode as being matched with the control information for the plurality of loads and the detection information of the at least one sensor.

5. The home appliance of claim 1,
wherein the communication module is configured to communicate with a user device and receive vibration information collected by the user device, and
wherein the instructions, when executed by the at least one processor individually or collectively, further cause the home appliance to:
control the communication module to transmit, to the server, the vibration information received during the first diagnosis mode as being matched with the control information for the plurality of loads and the detection information of the at least one sensor, and
control the communication module to transmit, to the server, the vibration information received during the second diagnosis mode as being matched with the control information for the plurality of loads and the detection information of the at least one sensor.

6. The home appliance of claim 1,
wherein the communication module is configured to communicate with a user device, and
wherein the instructions, when executed by the at least one processor individually or collectively, further cause the home appliance to:
control the first diagnosis mode to be performed based on a command to perform the first diagnosis mode being received from the user device,
control the second diagnosis mode to be performed based on a command to perform the second diagnosis mode being received from the user device, and
control the output module to output the diagnosis result information in response to the diagnosis result information being received from the user device.

7. The home appliance of claim 1,
wherein the plurality of loads comprises a driving motor for rotating a drum arranged in a tub; a drain pump for draining water from the tub; and a water supply valve for supplying water into the tub, and
wherein the instructions, when executed by the at least one processor individually or collectively, further cause the home appliance to:
control a washing process, a water supply process, a dehydrating process and a draining process based on the diagnosis control information,
recognize whether the drum is in an unloaded state during the washing process, and
control the output module to output indication information requesting draw-out of laundry based on the drum being recognized as in a loaded state.

8. The home appliance of claim 7, wherein the instructions, when executed by the at least one processor individually or collectively, further cause the home appliance to:
control the washing process, the water supply process, the dehydrating process and the draining process,
control the driving motor, the drain pump and the water supply valve, and
recognize control information for the drain pump and control information for the water supply valve in the unloaded state of the drum.

9. The home appliance of claim 7, further comprising:
a water level sensor configured to detect a water level in the tub; and
a speed sensor configured to detect rotation speed of the driving motor,
wherein the instructions, when executed by the at least one processor individually or collectively, further cause the home appliance to control the communication module to transmit, to the server, water level information detected by the water level sensor and rotation speed information detected by the speed sensor.

10. The home appliance of claim 9, further comprising:
a current sensor configured to detect a current flowing to the driving motor,
wherein the instructions, when executed by the at least one processor individually or collectively, further cause the home appliance to:
recognize a current process information based on a command to perform the second diagnosis mode being received,
recognize weight information of laundry based on current information detected by the current sensor, and
control the communication module to transmit, to the server, the recognized current process information, the weight information of the laundry and the water level information.

11. The home appliance of claim 1, further comprising:
a driving motor configured to rotate a drum arranged in a tub; and
a drying device configured to dry laundry in the drum,
wherein the drying device comprises a heat pump including a compressor, a blower fan blowing air produced by the heat pump into the drum, and a cooling fan cooling the compressor, and
wherein the instructions, when executed by the at least one processor individually or collectively, further cause the home appliance to:
control a drying process based on the diagnosis control information,
recognize control information for the driving motor, control information for the compressor,
control information for the blower fan, and
control information for the cooling fan while controlling the drying process.

12. The home appliance of claim 11, further comprising:
a first speed sensor configured to detect rotation speed of the driving motor;
a second speed sensor configured to detect rotation speed of a motor for compressor arranged in the compressor;
a third speed sensor configured to detect rotation speed of a first motor arranged in the blower fan; and
a fourth speed sensor configured to detect rotation velocity of a second motor arranged in the cooling fan,
wherein the instructions, when executed by the at least one processor individually or collectively, further cause the home appliance to control the communication module to transmit, to the server, rotation speed information detected by the first, second, third and fourth speed sensors while controlling the drying process.

13. A server comprising:
a communication module configured to communicate with a home appliance and a user device;
memory, comprising one or more storage media, storing instructions; and
at least one processor communicatively coupled to the communication module and the memory,
wherein the instructions, when executed by the at least one processor individually or collectively, cause the server to:
diagnose a failure of the home appliance based on reference diagnosis information,
control information for a plurality of loads received from the home appliance and sound information received from the user device, and
control the communication module to transmit diagnosis result information to at least one of the home appliance and the user device.

14. The server of claim 13, wherein the instructions, when executed by the at least one processor individually or collectively, further cause the server to:
control the communication module to transmit diagnosis control information required to perform a first diagnosis mode to the home appliance, and
diagnose a failure related with the plurality of loads based on performance information of the first diagnosis mode and detection information of a plurality of sensors arranged in the home appliance being received from the home appliance, and
diagnose a failure related to at least one of the plurality of loads based on performance information of a second diagnosis mode and control information for at least one load of the plurality of loads being received from the home appliance.

15. The server of claim 14, wherein the instructions, when executed by the at least one processor individually or collectively, further cause the server to diagnose a failure of the home appliance based on at least one of the reference diagnosis information, the control information for the plurality of loads received from the home appliance and sound information and vibration information received from the home appliance in response to at least one of the sound information and the vibration information being received from the home appliance.

16. The server of claim 15, wherein the plurality of sensors comprise at least one of a microphone for detecting sound and a vibration sensor for detecting vibration.

17. The server of claim 15, wherein the instructions, when executed by the at least one processor individually or collectively, further cause the server to store at least one of sound information detected by a microphone and vibration information detected by a vibration sensor based on a performance time of the first diagnosis mode as being matched with the control information for the plurality of loads and the detection information detected by at least one sensor.

18. The server of claim 15, wherein the instructions, when executed by the at least one processor individually or collectively, further cause the server to:
control the second diagnosis mode to be performed for a reference diagnosis time, and
store at least one of sound information detected by a microphone and vibration information detected by a vibration sensor based on a performance time of the second diagnosis mode as being matched with the control information for the plurality of loads and the detection information detected by at least one sensor.

19. The server of claim 15, wherein the instructions, when executed by the at least one processor individually or collectively, further cause the server to control the communication module to transmit, to the server, the sound information received during the first diagnosis mode as being matched with the control information for the plurality of loads and the detection information of at least one sensor.

20. The server of claim 15, wherein the instructions, when executed by the at least one processor individually or collectively, further cause the server to control the communication module to transmit, to the server, the sound information received during the second diagnosis mode as being matched with the control information for the plurality of loads and the detection information of at least one sensor.
